(19) United States
(12) Patent Application Publication
(10) Pub. No.: US 2012/0116577 A1
(43) Pub. Date: May 10, 2012

(54) AUTOMATED FOOD SERVICE SYSTEM FOR REMOTE RECREATIONAL FACILITIES

(76) Inventor: Frank Ottomanelli, Maspeth, NY (US)

(21) Appl. No.: 13/283,563

(22) Filed: Oct. 27, 2011

Related U.S. Application Data
(63) Continuation-in-part of application No. 12/582,059, filed on Oct. 20, 2009, now abandoned.
Application No. 12/582,059 is a continuation-in-part of application No. 29/317,618, filed on May 2, 2008, now Pat. No. D602531.
Application No. 29/317,618 is a continuation-in-part of application No. 11/132,238, filed on May 19, 2005, now abandoned.
(60) Provisional application No. 60/572,100, filed on May 19, 2004.

(51) Int. Cl. G06F 17/00

(52) U.S. Cl. 700/232

(57) ABSTRACT

A system is described which allows the delivery of butcher shop meat services to a remote location, such as marinas, campsites, parks etc., without significant input required from on site management personnel. Management operations are performed from a remote location. This includes food item selection, preliminary preparation, monitoring of inventories (and re-supply when necessary) and payments. By using this system, managers of remote locations can significantly enhance the ability to meet customers' needs without having to hire or train butcher shop personnel to manage each site.

This application is a continuation-in-part of U.S. Provisional application Ser. No. 12/582,059 filed on Oct. 20, 2009 which is a continuation-in-part of U.S. design application 29/317,618 filed on May 2, 2008 which has issued as U.S. Pat. No. D602,531 on Oct. 20, 2009, which is a continuation-in-part of U.S. patent application Ser. No. 11/132,238 filed on May 19, 2005, now abandoned, which claims benefit of U.S. Provisional Application 60/572,100 filed on May 19, 2004. Pat. No. D602,531 and U.S. application Ser. Nos. 12/582,059, 11/132,238, and 60/572,100 are hereby incorporated by reference in their entireties.

### BACKGROUND OF THE INVENTION

Outdoor camping, picnicking etc. are common leisure pastimes. Frequently associated with such occasions is outdoor cooking on a charcoal or gas grill a smoker or other outdoor cooking apparatus. Traditional grilled foods include hamburgers, steaks, sausages etc. For cooking on a patio or in a backyard, the food is readily available. However, outdoor cooking is also performed at remote locations having no access to household refrigerators and conveniences. At these locations, supplying food can be an important and limiting consideration.

At outdoor cooking locations, usually the only locally available food, if any, is typically soft drinks, candy bars and other snack foods. Accordingly, travelers away from home must bring their own food for cooking. This practice has several disadvantages. The amount of food is substantially limited by the size of the food container, usually a cooler or ice chest. Container capacity is further limited by the presence of various means of keeping the content frozen; ice, dry ice, cool packs etc. Moreover, the frozen food begins to thaw almost immediately and is preserved for only about a single day. When the content of a cooler approaches room temperature, the consumer will face an uncertain deadline after which food is no longer safe to consume. Being highly adverse to the risk of food poisoning, a consumer will often discard food of questionable freshness even though the consumer cannot be sure that the food had actually gone bad.

Vending machines are well known in the art. There are many designs that can be adapted to deliver butcher shop meat products to the consumer at a remote location. Such suitable machines are described in U.S. Pat. No. 6,779,684 to Suk-Ho Shin, Suwon-si issued on Aug. 24, 2008, U.S. Pat. No. 7,055,716 to Holdway et al. issued on Jun. 6, 2006, U.S. Pat. No. 7,182,219 to Chang issued Feb. 27, 2007, U.S. Pat. No. 7,401,710 to Black et al. issued on Jul. 22, 2008 and 7,086,560 to Shioya, Morihisa issued on Aug. 8, 2006 each is hereby incorporated by reference in its entirety. Similarly, there also many known solutions to communicate with remote devices such as a vending machine, such methods are described in U.S. Pat. No. 7,889,852 to Craig Whitehead issued on Feb. 15, 2011, U.S. Patent Application Publication 20040046637 to Eveline Wesby Van Swaay published on Mar. 11, 2004 and U.S. Pat. No. 7,870,029 to Bates et al. issued on Jan. 11, 2011 each is hereby incorporated by reference in its entirety.

### OBJECTS OF THE INVENTION

It is a general object of the invention to relieve the traveler of concerns about packing and preserving food for use in outdoor cooking.

Another general object of the invention is to provide a food service at a remote site that requires little or no effort on behalf of a remote site manager.

A further object of the invention is to effectively provide butcher shop service at remote locations.

Another object of the invention is to provide the remote service continuously; round-the-clock, seven-days-a-week.

A further object is to provide automated or self service butcher shop service where food products are dispensed and paid for without direct input from a butcher shop proprietor.

A still further object of the invention is to provide for efficient management of a remote butcher shop where inventories are automatically recorded and the operational conditions of machinery are automatically measured and recorded.

Still another object of the invention is to provide for remote management requiring little or no specific effort from the local site manager.

Another object of the invention to efficiently control a plurality of remote butcher shop service locations.

### BRIEF SUMMARY OF THE INVENTION

An embodiment of the present invention that is intended to accomplish at least some of the foregoing objects comprises a system for dispensing fresh and frozen food to consumers at remote locations. Remote locations include marinas, campgrounds, urban parks and other locations. The system also includes small environmentally friendly self-service automated retail shops that will provide round-the-clock service, seven days-a-week. The shop can be configured to accept both cash and cashless payment, provide computerized transaction records and 24/7 telemetry to monitor performance, facilitate and accelerate stock replenishment and maintenance by allowing remote access to the telemetry. In a preferred embodiment, delivery and maintenance personnel can access the information, with a handheld device, either directly from the machine or indirectly from off site locations such as an internet web page.

### BRIEF DESCRIPTION OF THE DRAWINGS

FIG. 1 illustrates a front view of an automatic butcher shop showing a typical selection of butcher shop food available for campground consumers;

FIG. 2 is a front view of a clear door vending machine embodying the teachings of the subject invention;

FIGS. 3 through 10 relate to the product separation and selection tray system which is adjustable and removable from the clear door vending machine;

FIG. 3 is a front perspective view of the product separation and selection tray system of the present invention;

FIG. 4 is a rear perspective view of the product separation and selection tray system;

FIG. 5 is a side view of the product separation and selection tray system;

FIG. 5A is a front view of an alternate embodiment of a product separation and selection tray system having an adjustable top support assembly for controlling the separation of opposing side walls from a central wall;

FIG. 5B is a front perspective view illustrating the details of the top support assembly;

FIG. 5C is a rear perspective view showing the details of the top support assembly;

FIG. 5D is an enlarged detailed view of the top support assembly mounted on a central wall of a cell assembly and illustrating opposing slidable top straps for engagement with opposed sidewalls;

FIG. 5E illustrates the top support assembly with one half of the assembly removed;

FIG. 5F is a side view of the top support assembly illustrating the internal workings of the top support assembly as seen through one of its side walls;

FIG. 6 is a bottom view of the product separation and selection tray system;

FIG. 7 is an exploded front perspective view of the product separation and selection tray system;

FIG. 8 is a front view of the product separation and selection tray system;

FIG. 9 is a rear view of the product separation and selection tray system;

FIG. 10 is a top plan view of the product separation and selection tray system;

FIG. 11 is a plan view of an X-Y axis product acquisition and transport system aligned with one column of the product separation and selection tray system prior to engagement of a projecting tab portion of a lever for release of product to a cup of the product acquisition and transport system;

FIG. 11A illustrates the details of a pusher assembly used to advance a product to be dispensed along a tray with a negator spring drum shown in a position of rest;

FIG. 11B is a rear view of the pusher assembly with the negator spring drum rotatably mounted in a foot which is used as a stop for a lesser compressive spring pushing on product to be dispensed;

FIG. 11C illustrates extension of the foot and therefore biasing of the negator spring drum by extension of a portion of the wound tape forming the drum so as to provide a bias force for return of the foot to the at rest position shown in FIG. 11A;

FIG. 12 is a plan view illustrating the engagement of the cup of the product acquisition and transport system by engagement with the projecting tab of the lever of the separation and selection tray system so as to pivot a rotator out of engagement with the product and pivot a gate into engagement with a successive product;

FIG. 13 illustrates the release of the projecting tab of the lever so as to pivot the gate into alignment with a central wall for advancement of the successive product and engagement with the rotator;

FIG. 14 is a front perspective view of FIG. 11;

FIG. 15 is a left front perspective view of FIG. 12;

FIG. 16 is a front view of the vending machine of the present invention with the front door pivoted away from the cabinet to access the interior of the cabinet;

FIG. 17 schematically illustrates the X-Y axis product acquisition and transport system of the present invention;

FIG. 18 is a front view of the cup of the product acquisition and transport system holding a product on one side of the front door of the vending machine with the details of the interior of the control panel and delivery port having been omitted for clarity;

FIG. 19 is a perspective view of the cup holding the product as shown in FIG. 18 to illustrate the horizontal rail on which the cup slides;

FIG. 20 is a perspective view from the opposite side of FIG. 19;

FIG. 21 schematically illustrates the mechanism for tilting of the cup by engagement of a projection on a side of the cup with a projection extending from a fixed wall of the product delivery system;

FIG. 22 illustrates the opening of a slidable outlet port door or window and subsequent tilting of the cup to slide the product into the outlet port basket which is tiltable towards the consumer for access to and withdrawal of the product;

FIG. 23 illustrates the elevator cup first opening the port latch and contacting the delivery door;

FIG. 24 illustrates the complete opening of the delivery door and the pivoting of the elevator cup to deliver product to the port box while the port latch has dropped down to engage a weld pin to prevent the delivery box from being opened during delivery of the product;

FIG. 25 shows additional details of the delivery mechanism;

FIG. 26 is a rear view of the delivery box;

FIG. 27 is an enlarged view of the area encircled in FIG. 26;

FIG. 28 shows a detailed view of an approaching elevator cup including product for delivery and initial engagement of the port latch of the delivery door;

FIG. 29 illustrates the initial opening of the port latch and the contact of the delivery door;

FIG. 30 illustrates a rear view of FIG. 24 where the elevator cup has completely opened the delivery door, delivered the product to the port box and allowed the port latch to drop down and engage a weld pin to prevent the delivery box from being opened.

FIG. 31 is a rear view of the port latch having moved from the position shown in FIG. 26 so as to engage the weld pin;

FIG. 32 is a rear view where the elevator cup has released the delivery door allowing the port latch to disengage the weld pin, allowing the weight of the product being vended to rotate the port box forward to present the product to the customer;

FIG. 33 is a side view of the delivery box pivoted forward to allow release of the product to the consumer;

FIG. 34 is an illustration of one example of a communications module in a remote embedded application;

FIG. 35 is a more detailed illustration of a communications link distributed over the Internet;

FIG. 36 illustrates schematically the use of (TCP Transmission Control Protocol) ports and sockets for the controlled transmission of data;

FIG. 37 is a simple flow chart to illustrate a method of establishing a file transfer session between a remote embedded application and an ISP Server, with dynamic Public Key assignment;

FIG. 38 is a simple flow diagram to illustrate the steps in an initial registration procedure; and

FIG. 39 is a simple flow diagram to illustrate the initial steps in establishing a connection between an ISP Server and a remote application by use of Calling Line Identification (CLI).

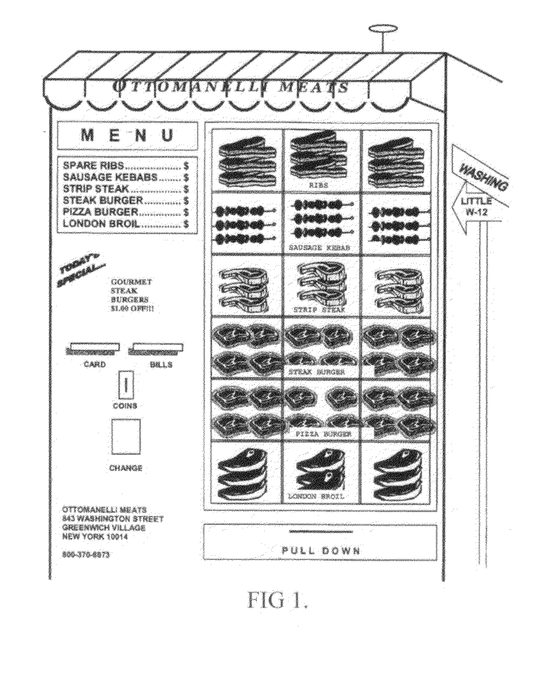

### DETAILED DESCRIPTION OF THE INVENTION

Managers of remote facilities seek to satisfy their customers with a clean, well run facility. By using the disclosed invention, these managers can provide an added value for their customers—for example, immediate on-site access to butcher shop services. More specifically, managers can provide a substantial selection of fresh and frozen food butcher shop items for outdoor cooking.

Ordinarily, it would be impractical for a marina or campground manager to supply butcher shop items. Substantial time commitments and experience are required to safely and profitably operate a butcher shop. One must deal knowledgeably with meat wholesalers and meat inspectors. Furthermore, one must know how to properly butcher sides of beef, know a myriad of public health and safety regulations and storage requirements to maintain meat in a safe and attractive display.

Finally, and perhaps most importantly, one must have a feel for what types of food items are popular with consumers. Stocking the correct items is critical for success of the operation which is dependent upon generating a reasonably large sales volume.

Surprisingly, the inventor has designed a practical system by which a remote site manager without any special knowledge in this field, can offer butcher shop services. As a result, a local manager can offer butcher shop retail services merely by supplying a 12 Amp, 110-volt electrical outlet.

Furthermore, the local manager will profit as a result of this service, either by receiving rental payments for the space allocated for the service or by receiving commissions based on the sales transactions. The manager will also profit in indirect ways. For example, a campground manager will provide an enhanced camping experience which will attract more campers, encourage campers to say on the campgrounds longer and return more often.

Remote locations will be provided with an automated dispensing apparatus stocked with carefully selected butcher shop food items. Such dispensing apparatus are portable. As used herein “portable” means able to be moved by a single human being through the use of a simple mechanical advantage, such as a hand truck or a dolly. Based on experience, each of the following selections are functional in the disclosed system. In order to be functional, each of the following foods must have physical properties such that they can be preserved for a sufficient time at the remote location and, after outdoor cooking, will suffer no significant losses in flavor.

The U.S. and Canadian Governments provide guidance and requirements for the food industry, of particular relevance are the guidance and requirements provided for the butcher and seafood industries. This information can be found in 21 C.F.R §§100-105, 110, 111, 113, 123, 130, 131, 133, 160, and 161 all cited sections of 21 C.F.R are hereby incorporated by reference in their entireties. In Canada analogous rules and guideline are provided in the Livestock and Poultry Carcass Grading Regulations, and the Meat Inspection Act of 1990, as well as the Fish Inspection Act, the three of which are hereby incorporated by reference in their entireties.

The specific method of cooking is also taken into account. The following foods are selected for compatibility with the specific types of outdoor cooking apparatus traditionally utilized: grills, gas grills, charcoal grills, hickory cooking, mesquite cooking, use of smokers, etc. In addition to the physical properties, these foods must have another property in order for the system to function optimally. Each of these food items are believed to be popular with the consumer found at the remote locations so that a sufficiently high sales volume can be established.

Some examples of the foods to be stocked are: ribs; marinated ribs; meat kebabs (chicken, beef, lamb, pork, etc); blackened chicken; chicken breasts; boneless strip steaks; filet mignon steaks, teriyaki steaks, hamburger, hamburger patties; pork chops, stuffed pork chops, beef London broil, Delmonico steaks, sirloin steak, Italian sausage, chicken cutlets, fish, and pork loin. On the other hand, some food items, while popular, are not practical for all but a few specific embodiments of this system; live Main lobsters, for example.

Some further specific examples of food items to be provided are: “country style” ribs marinated in barbecue sauce; precooked barbecue ribs; lemon/pepper chicken cutlets, cranberry stuffed chicken breast, gourmet steak burgers 90% lean, poached salmon in sweet red pepper sauce, and pork loin with apple sauce or apple cider sauce. It is also specifically contemplated to offer “all natural” or “organic” versions of the above food items.

Rather then building a permanent structure to house a retail shop, a portable structure will be utilized in accordance with a preferred embodiment of the invention. The various butcher shop items will be stored in an enclosed climate controlled structure. Specifically, the structure will be capable of refrigerating the items or freezing the items. Standard temperatures for refrigeration and freezing of butcher shop items can be used. The temperatures and atmospheric conditions inside the structure will be such that the food is preserved for the longest possible time without significantly effecting food quality.

In one preferred embodiment, humidity levels will be maintained such that the food will not undergo freezer burn. Alternatively, “frost free” freezing conditions can be used so long as steps are taken so that food items are rendered resistant to freezer burn. For example, the food items can be stored in individual compartments within the overall structure so that they will be substantially resistant to freezer burn. In another preferred embodiment, the food can be wrapper or otherwise packaged so as to be resistant to freezer burn. Any method of hermetically sealing the food can be used, for example vacuum sealing individual food items. Alternatively, the food stocks can be rotated or otherwise monitored so that the food does not remain under “frost free” conditions long enough for significant freezer burn to develop.

Preferably, stocking of the retail outlets will be accomplished by outside contractors. These contractors will monitor inventories by methods set forth below. When the stocks are depleted, the contractors will travel to the remote locations and restock the local retail shops. In one embodiment, the stocks are delivered to each individual retail shop from a central food warehouse. In another embodiment, a plurality of regional warehouses is used. Each regional warehouse is placed in a location convenient to service the retail shops in that region. Convenient regional warehouse locations can be, but need not be, a location central to that region's retail shops. Alternatively, the regional warehouse can be located close to a transportation hub; an airport, a common carrier pickup center, etc.

Regional warehouses are also contemplated when special needs arise, for example a group of retail shops that are close together but far from the central warehouse can be efficiently served from a regional warehouse. Also, retail shops with a high sales volume can be serviced from appropriately designed regional warehouses with extra storage space and delivery trucks to meet the high demand.

Another special design is to offer kosher food items. Sources of the ingredients are chosen and the status of all of the production, maintenance, delivery and storage equipment is monitored and controlled so as to ensure kosher certification from the appropriate authority.

Another preferred embodiment includes devices that can monitor the inventory automatically and report this data automatically. The inventory data can be obtained by a visit to the local retail site. Any manual or automatic method of reading data can be used in the invention. The inventory data can be read directly from a display on the structure and recorded on a clipboard. Alternatively, data can be read automatically by a hand held device, or laptop computer, then up loaded to a suitable database. An example of a suitable database would be a file server that can be accessed via an internet connection.

Still another suitable mode of data collection is to equip the local retail shop with a device capable of transmitting the data to a remote location without the need for a visit to the remote location. For example, inventory data can be sent by an internet connection to a site on the internet. In effect, the remote shop will automatically report its current inventory to the internet site. Thus, the supplier can stock his truck appropriately by monitoring the internet site without first having to visit the remote shop.

Food items will be displayed and dispensed to consumers in a similar manner to standard vending machines. Typically, the food is displayed with the use of transparent doors so that the consumer can see the food prior to making a purchasing decision. The price for each food item is displayed next to the food item. After the consumer tenders the appropriate payment, the food item is made accessible to the consumer using any of the myriad devices developed for use with vending machines. One specific embodiment of a preferred device is described below. Suitable devices are also described in U.S. Pat. No. 6,779,684 to Suk-Ho Shin, Suwon-si issued on Aug. 24, 2008, U.S. Pat. No. 7,055,716 to Holdway et al. issued on Jun. 6, 2006, U.S. Pat. No. 7,182,219 to Chang issued Feb. 27, 2007, U.S. Pat. No. 7,401,710 to Black et al. issued on Jul. 22, 2008 and 7,086,560 to Shioya, Morihisa issued on Aug. 8, 2006.

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose. For instance for simplicity the vending item described is a breakable bottle, however, it is understood that fragile butcher cuts, fish filets, or even live lobster in a glass container with sea water could be substituted for the bottle in the below description.

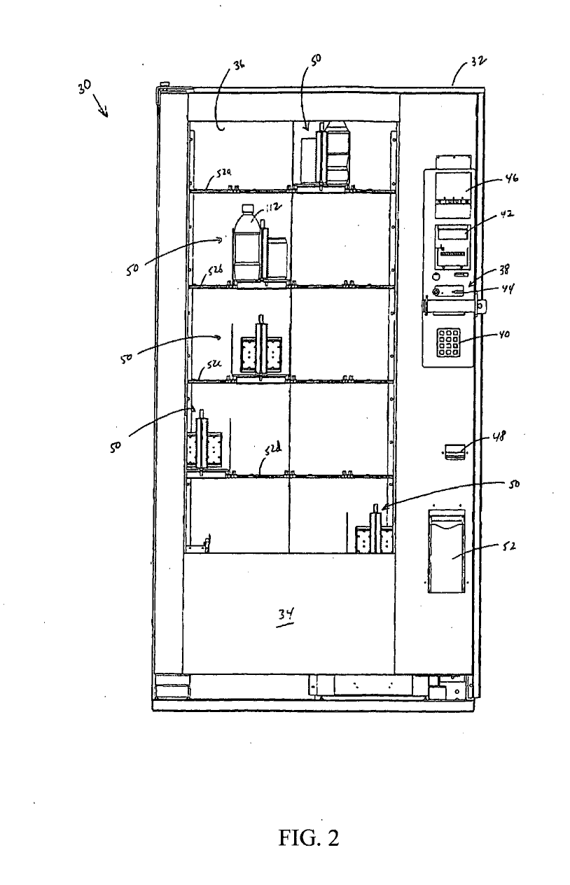

With reference to the drawings, in general, and to FIG. 2 in particular, an automated food service system for remote recreational facilities embodying the teachings of the subject invention is generally designated as 30. With reference to its orientation in FIG. 2, the clear door vending machine includes a cabinet 32 with a front door 34 having a clear panel portion 36.

On the front face of the door 34 is located a control panel 38 having a digital keypad 40. Information entered into the digital keypad is displayed in display panel 42. In addition, the control panel 38 includes coin slot 44 and dollar bill receiver 46, as well as a change return slot 48.

Representative samples of product separation and selection tray systems 50 for dispensing product through a delivery port 52 are seen through the panel 36. A random scattering of the product separation and selection tray systems 50 is shown in FIG. 2, it being understood that each of the shelves 52a, 52b, 52c, 52d and shelf 52e (not shown) can accommodate up to four systems 50 on each shelf in the present width configuration of the systems 50. The sidewalls of each system 50 are movable laterally to accommodate smaller or larger sized product to be dispensed by the vending machine 30 of the present invention.

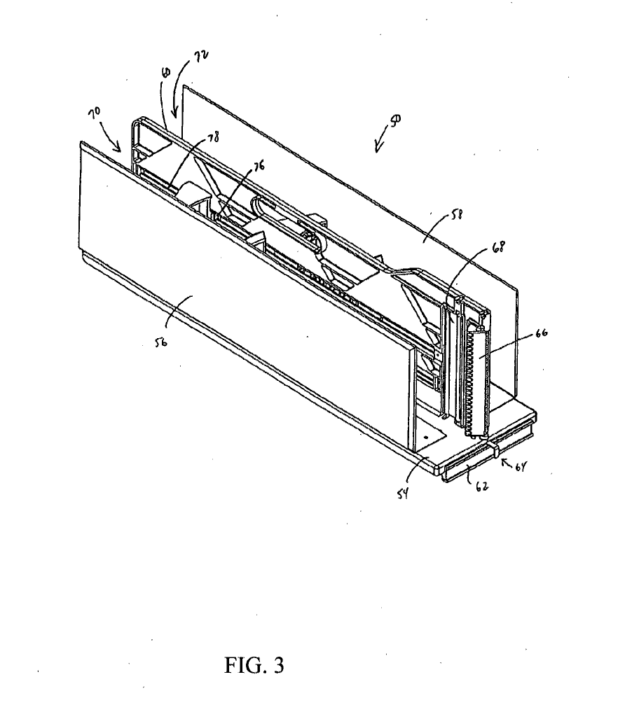

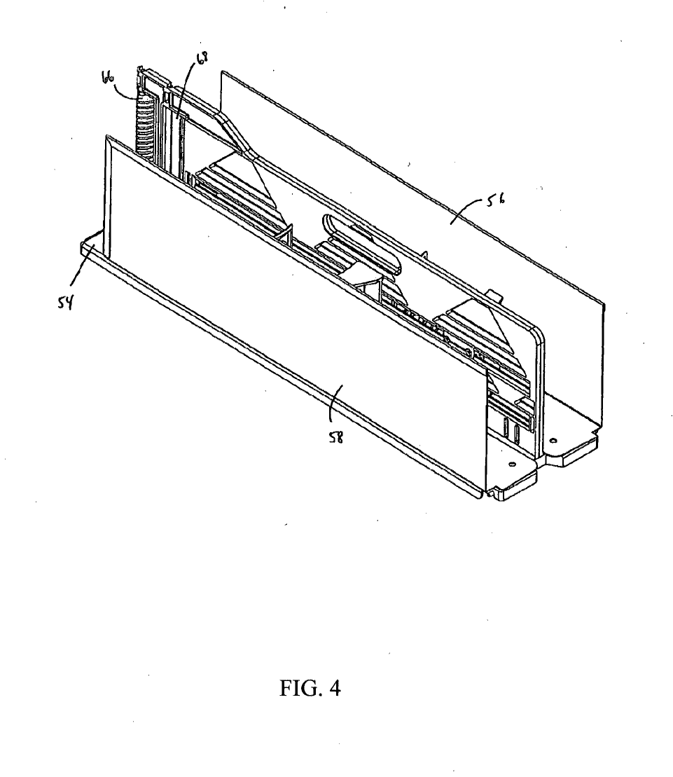

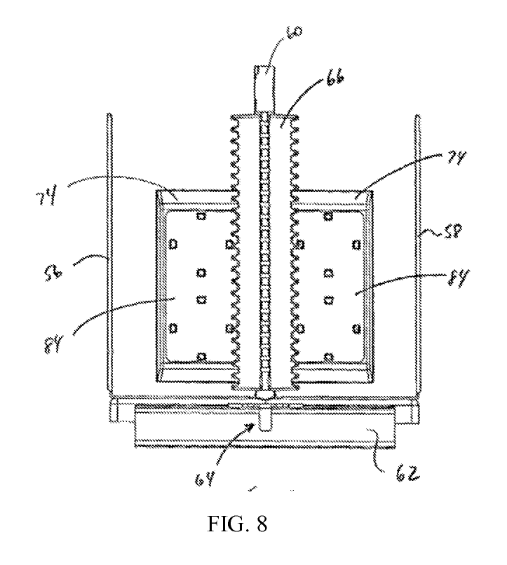

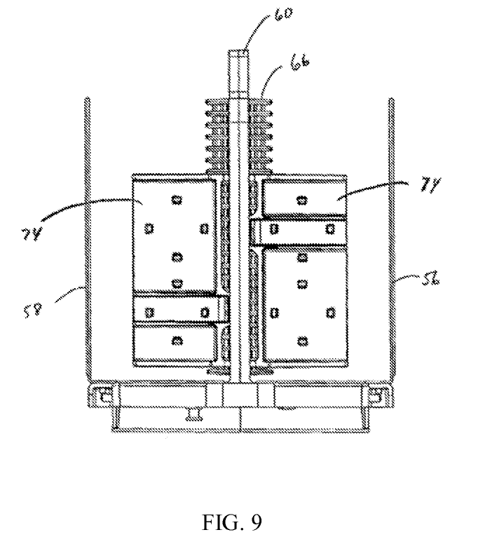

FIGS. 3 through 10 are various views of the product separation and selection tray system according to the present invention. As shown in FIG. 3, for example, the system 50 includes a base 54 and two opposed L-shaped side walls 56 and 58. The side walls 56 and 58 are slidably mounted on the base 54 so as to be able to be varied in lateral separation distance from each other and from central fixed dividing wall 60 to accommodate various sized products to be dispensed.

To control the separation distance between sidewalls 56 and 58, an adjustable top support assembly 320 is mounted on top of central fixed dividing wall 60. The top support assembly 320 not only controls the separation distance between the sidewalls 56 and 58 but reinforces the upper extremities of the sidewalls so that the sidewalls do not bow outwardly due to the force of products being pushed along the base 54 of a system 50.

The adjustable top support assembly includes two top straps 322 which extend from the centrally located support assembly 320. One end 324 of each top strap 322 is L-shaped for anchoring to the sidewalls 56 and 58. The opposite end 326 of the straps 322 is slidably mounted through slots in both of the two sidewalls 328 and 330 of the support assembly.

Extending from each of the sidewalls 328, 330 is an indicia plate 332, 334, respectively. The indicia on plates 332, 334 may include a scale with hash marks which matches the markings on plates 336, 338 located on the base 54 of the system 50. The relative positioning of the sidewalls 56, 58 with respect to the indicia at the base 54 and on the plates 332, 334 should match to ensure that the separation of the sidewalls 56, 58 is the same at the top and at the bottom of the sidewalls.

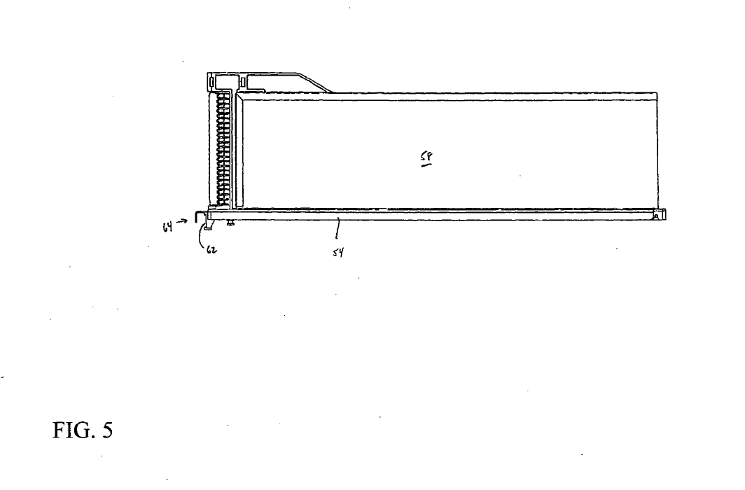

As shown in FIG. 5D, each of the top straps 322, includes a pointer arrow 340 which provides an indication of the relative positioning of the movable straps 322 to the fixed plates 332, 334 for viewing the relative positioning of the upper portions of the sidewalls 56, 58. This positioning is compared to the markings of an arrow 342 on a projection 344 of the sidewalls 56, 58.

To control the position of the straps 322 as they pass through slots in the sidewalls 328, 330 of the support assembly, a spring bias system and finger controlled strap lockers are located between the sidewalls 328, 330. The strap lockers 346 extend out in front of the support assembly 320 so as to be grabable and squeezed together by the fingers of an operator so as to release the bias on the ends 326 of the top straps 322 as they pass through slots in the upper ends of the sidewalls 328, 330.

As shown in FIGS. 5E and 5F, the top strap 322 passes through the side plate 330, the side plate 328 having been removed in this Figure to view the interior between the two side plates 328, 330.

The strap locker 346 is pivotally mounted on a strap locker pivot 348. A spring 350 extends between an anchor 352 mounted on an extension of the strap locker 346 and the opposite end of the spring 350 is mounted on an anchor 354 secured to the side plate 330. It is therefore seen that the plate terminating in the strap locker 346 is pivoted so as to engage the strap locker 322 as the strap locker 322 passes through slots in the sidewalls 328, 330.

By pushing the two strap lockers together 346 by manual manipulation, the bias force may be removed to allow free sliding of the top straps 322 through the slots in the sidewalls 328, 330. Upon release of the strap lockers spring 350 and an additional spring 356 extending between anchors 358 and 360, the strap lockers are controllable to either lock or release the sliding of the top straps 322 through the slots of the sidewalls 328, 330.

Regulation of the movements of the upper ends of the sidewalls 56, 58 is thereby accomplished so that the separation distance between the sidewalls 56, 58 is the same at their top as compared to their bottom. This strengthens the overall assembly and controls any tendency for the upper ends of the sidewalls to move apart.

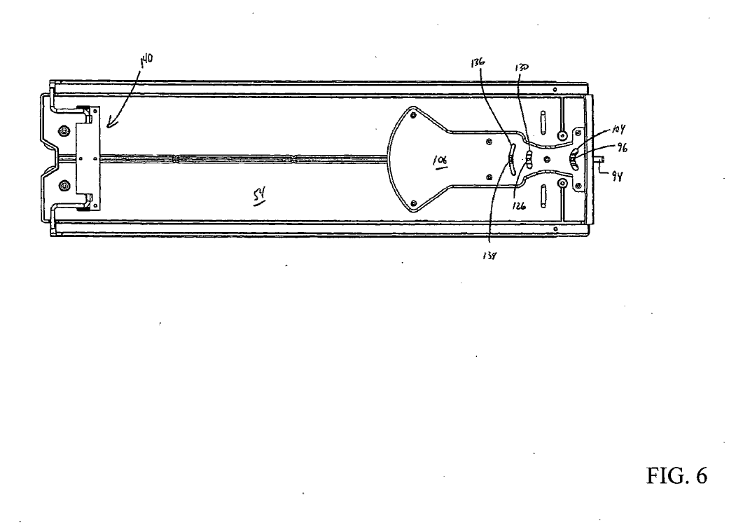

An indicia display holder 62 (made of component parts 62a and 62b, as shown in FIG. 6) is located on a leading edge of base 54. Display holder is used to identify a product's name, a price of the product and/or to identify indicia to be entered into keypad 40 to select a particular product.

Projecting in front of the label holder 62 is an actuating lever 64. Actuating lever 64 controls operation of a rotator 66 and a gate 68 for dispensing of product from a space 70 defined between side wall 56 and central wall 60 or a space 72 defined between central wall 60 and end wall 58.

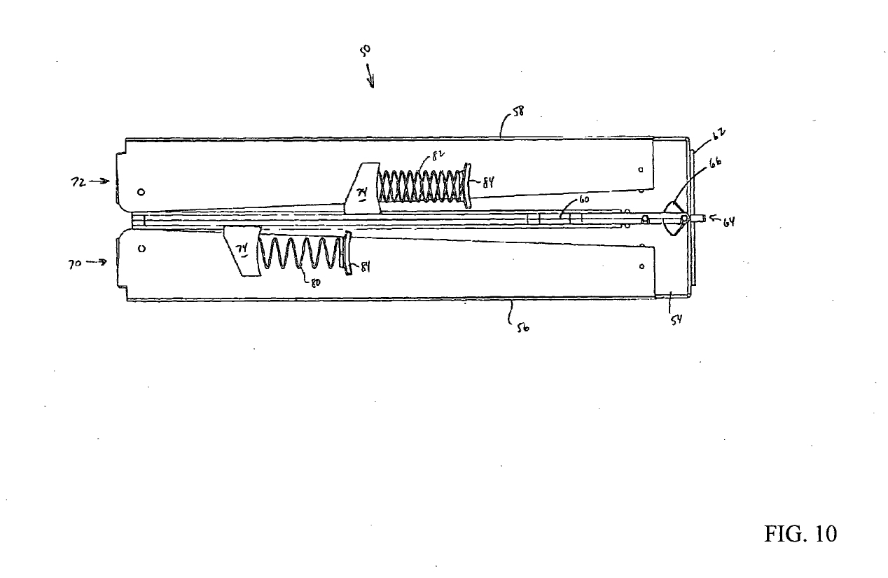

As shown in FIG. 10 product is moved toward the leading edge of the system 50 by the use of feet 74 having a projection 76 which is slidable in a track 78 of the central wall 60 for placement of the feet relative to the forward end of the base 54. Alternatively, the track may be positioned in the base.

Projecting forwardly from the feet 74 is either a single helix spring 80 or double helix spring 82 terminating in a slider 84. The force of the springs 80 or 82 is sufficient to advance product in the direction of rotator 66 for dispensing of product into a delivery cup as will be explained in more detail later.

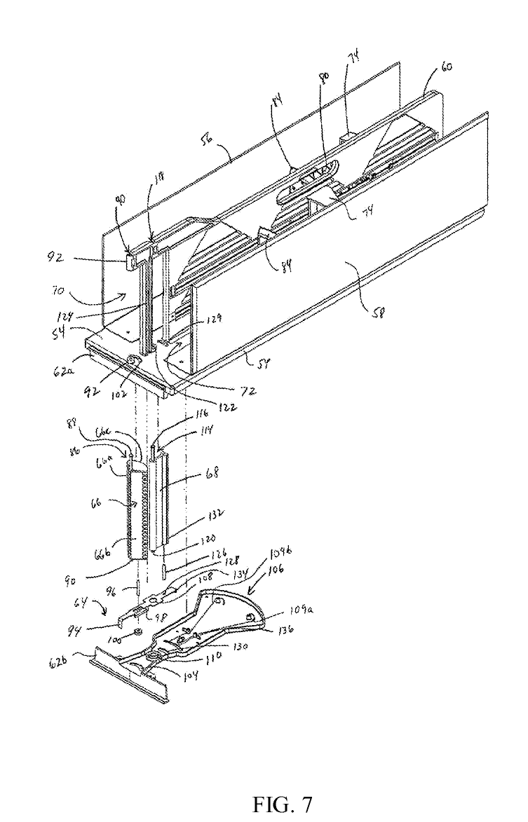

As will be explained with reference to FIGS. 6 and 7, the product separation and selection tray system of the present invention includes rotator 66 having flat side surfaces 66a and 66b intersecting at one end and terminating at an opposite end in curved surfaces 66c. At the intersection of flat surfaces 66a, 66b, is located an extended pin 86 having head 88 engaged in recess 90 at a leading edge 92 of central wall 60. The opposite end 90 of pin 86 is engaged in a bushing 92 mounted on the upper surface of base 54.

The pin 86 fixed in the rotator 66 allows pivotal movement of the rotator during movement of the tab portion 94 of the lever 64. A pin 96 extends through arcuate slot 102 in the base 54 and through a slot 98 in the lever 64 to engage at its bottom end in bushing 100. Pin 96 then passes into arcuate slot 104 of retaining plate 106. Retaining plate 106 is secured to the underside of the base 54 as shown in FIG. 5. The upper end of pin 96 is secured within rotator 66 at a point midway between sides 66a and 66b along a radial line projecting from pin 86 in the direction of curved side 66c. The lever 64 is pivoted around boss 110 by the anchoring of circular opening 108 of the lever 64 in the boss 110 projecting upwardly from the retaining plate 106.

For example, the rotators 66 shown on shelves 52a, 52c, 52d and 52e in FIG. 2, illustrate the normal, at rest positioning of the rotators 66. However, when the tab 94 is contacted and moved to the right as shown in the system 50 on shelf 52b, the rotator 66 is pivoted such that side 66a is in line, parallel with central wall 60. Then rotator 66 allows product 112 to be advanced past rotator 66 under the bias force of spring 80.

Simultaneous with the shifting of the rotator 66 is the movement of the gate 68 in an opposite direction. Gate 68 is mounted at one end on an elongated pin 114 having pin head 116 mounted in a recess 118 in central wall 60. The bottom end 120 of the pin 114 is mounted in a circular recess 122 defined in a partition 124 separating the rotator 66 from the gate 68.

A pin 126 extends through a circular opening 128 in the lever 64 and then passes through arcuate slot 129 in base 54 and arcuate slot 130 in the retaining plate 106. The opposite end of pin 126 is secured in a recess in a trailing edge 132 of gate 68. A rear terminal flange 134 of the lever 64 is slidable in arcuate slot 136 in retaining plate 106.

In operation, when the tab 94 of lever 64 is moved in one direction, the lever 64 pivots about pivot boss 110 and the retaining flange 134 at the opposite end of the lever 64 moves in the opposite direction to the tab 94. This action causes side 66a of rotator 66 to move to a position parallel to central wall 60. Gate 68 will simultaneously move its rear edge 132 in a direction perpendicular to central wall 60 in channel 70 so as to prevent advancement of a second, successive product in channel 70 against the bias force of spring 80.

When force on tab 94 of lever 64 is released, two springs 109a, 109b return the lever 64 to its central, at rest position. This bias force would then force gate 68 to its at rest position, parallel to and within the confines of central wall 60. The rotator 66 would also pivot to its at rest position as shown in the system 50 on shelf 52a, for example. The return of the gate 68 to its alignment with central wall 60 would allow advancement of the second, successive product under the force of spring 80 until engaging with the rotator 66, ready for the next dispensing operation.

By the adjustment of the sidewalls 56, 58, different sized products may be preloaded at a remote location onto a product separation and selection tray system of the present invention. When refilling the vending machine, an existing empty tray system 50 may be removed and replaced by a preloaded tray system 50. Determination of product to be dispensed may thereby be made at a remote location with removal of an existing tray system and insertion of a new tray system at the vending machine.

Alternatively, new product may be pushed in from the front. Also, it is possible to remove the tray “on site” and add new product from the rear of the tray.

It is understood as being within the scope of the present invention that an engaging mechanism 140 as shown on the underside of the base 54 in FIG. 7, can be used to engage with complementary shaped openings in a rear portion of shelves 52a through 52e. Therefore, as long as the total width of each shelf is known, the modular feature of the tray system 50 may be used to design mounting of an appropriate number of tray systems 50 on each shelf.

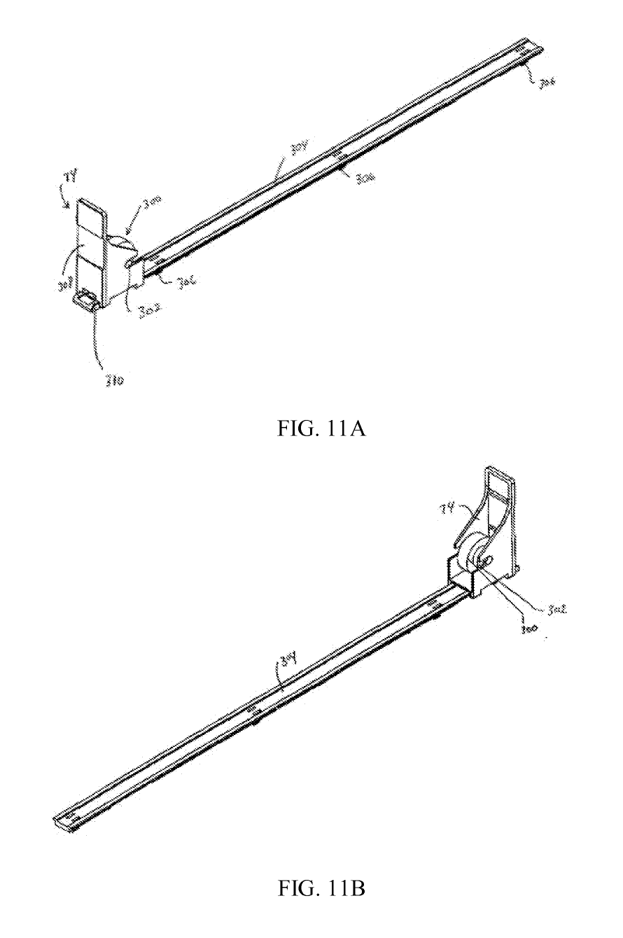

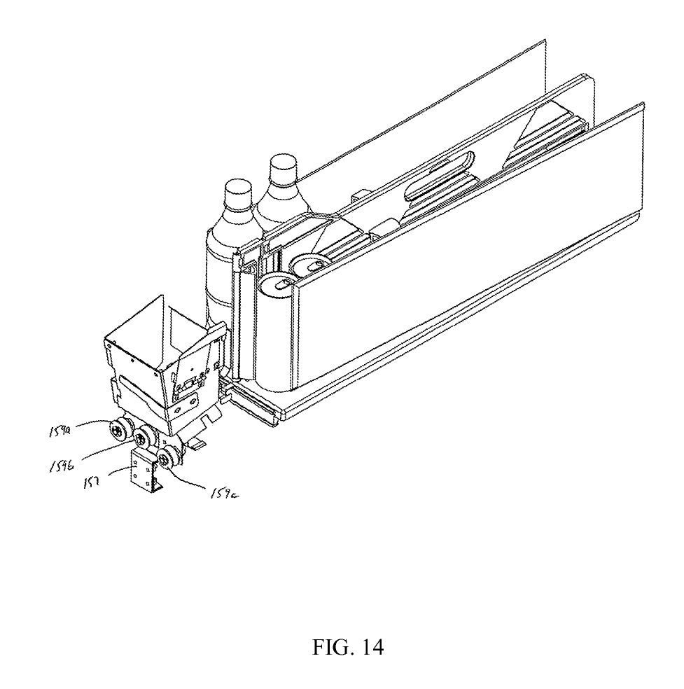

In FIGS. 12 through 16, the progression of release of product 112 into an elevator cup 150 of a product acquisition and transport system is illustrated. Initially, the X-Y axis product acquisition and transport system is driven, based upon keypad actuation of a desired choice of product to raise the elevator cup in the Y-direction with selection channel 95 surrounding tab 94 of lever 64. As shown in FIG. 12, when the tab 94 of lever 64 is engaged by a sidewall 152 of channel 95, upon sideways movement of the cup 150, the rotator 66 moves out of the way of the product 112 and the gate 68 engages the next successive bottle or other vending item 154.

The forward movement of the bottle or other vending item 154 is actuated by the slider 84, as biased by spring 80, until the bottle 154 engages the gate 68 as shown in FIG. 12.

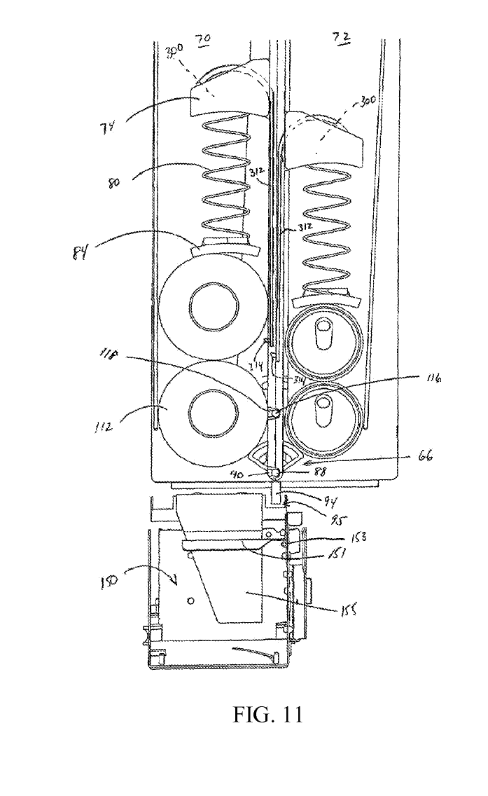

Alternatively, foot 74 is biased by a flat wound negator spring as shown in FIGS. 11, 11A, 11B and 11C. This is the primary force on the bottles or other vending items. Negator spring 300 is shown in the Figures in a wound state, rotatably mounted in foot 74 by axial pin 302. Foot 74 is slidably mounted in a guide track 304 which may be secured to a side of a wall extending in a central portion of each product tray. Tabs 306 may be used to anchor the tray 304 in the side of central wall of the tray.

The foot 74 includes a recessed portion 308 for anchoring one end of spring 80 as shown in FIG. 11. The base of the foot 74 includes an opening 310 through which a portion of the wound tape forming negator spring 300 may extend as shown in FIG. 12C. Extended portion 312 of spring 300 is anchored by pin 314 in the guide track 304.

When the foot 74 is moved to the right with reference to FIGS. 12A and 12C and as shown in FIG. 12, the portion 312 extends from the foot 74. The natural tendency of the negator spring 300 to rewind to the rest position shown in FIG. 12A biases the foot to move to the left with reference to FIGS. 12A and 12C and thereby force spring 80 to move slider 84 into contact with a product to be dispensed. Alternatively, spring 80 may be omitted and the foot 74 directly engaged with the product to be dispensed.

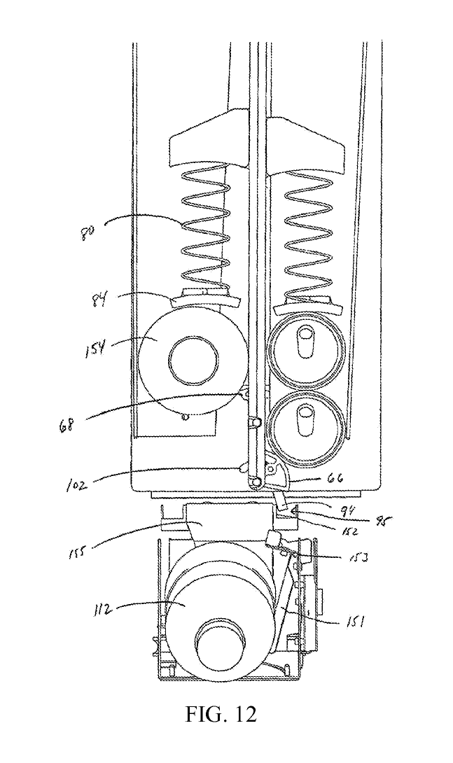

Spring 80 and slider 84 are used to move the last bottle or other final item past the gate and rotator. The release of the tab 94 by reverse lateral movement of the cup 150 to the position shown in FIG. 14 releases the gate from engaging the bottle 154 and allows forward movement of the bottle 154 until engaging the rotator 66.

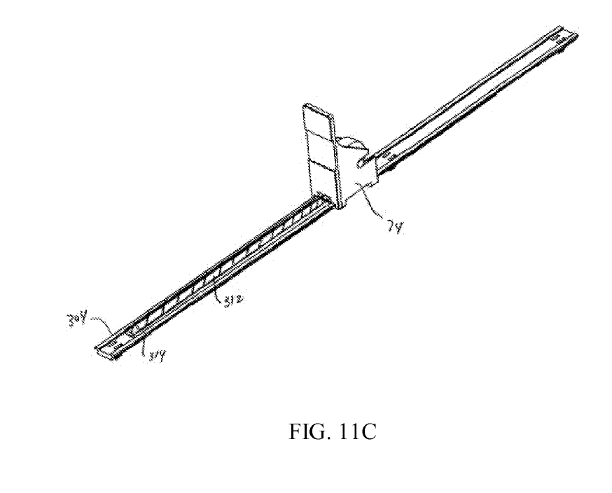

During forward movement of the bottle or other vending item 112, a sensor confirms placement of product in the elevator cup 150. As shown in FIG. 12, vertically extending flange 151 extends across the path of product in the cup 150. As shown in FIG. 13, the flange 151 is pivoted about pin 153 when product is pushed into the cup 150. Pivotable flange 155 stabilizes the bottle or other vending item in the cup. A switch 153 is not actuated by flange 151 thereby indicating presence of a bottle.

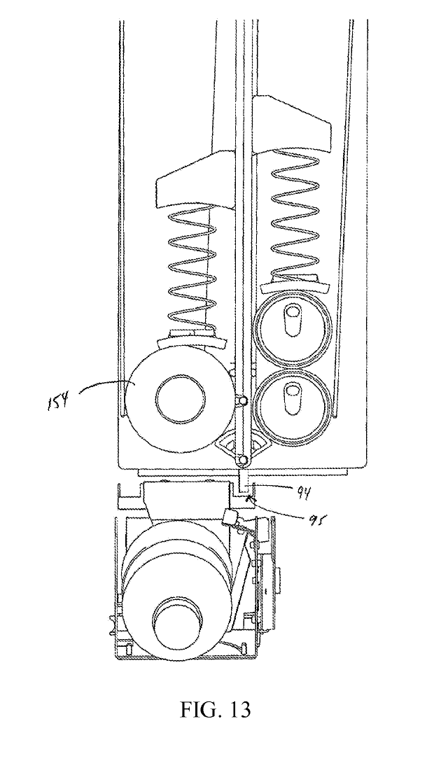

FIGS. 14 and 15 show details of the flange 157 for use in guiding movement of the cup 150 with respect to horizontal movement by connection to a tension element such as a horizontal toothed belt. Also guide wheels 159a, 159b, 159c assist in traversing along a horizontal guide rail as the guide rail is raised vertically for positioning of the cup in front of a tray system 50.

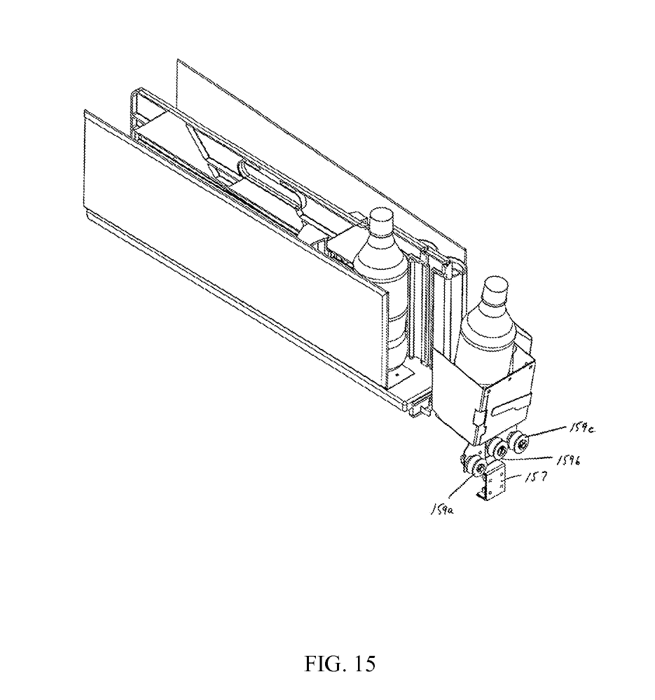

FIG. 17 schematically illustrates the product acquisition and transport system 160 for movement of the cup 150 to any position in front of a product to be dispensed as well as for movement of the cup to deliver the product to a discharge port. Cup 150 is secured to tension element 162 which may be a belt, chain or cable for movement of the cup by rotation of a fixed motor 164. The motor is connected by a drive shaft 166 to a drive roller 168. Actuation of the motor causes the tension element 162 to run across driven rollers 170, 172, 174 and 176. The rollers 170, 172, 174 are mounted on a horizontal rail 178. When the rail 178 is fixed in position, movement of the tension element 162 causes the cup 150 to traverse the rail so as to be located in front of a particular separation and selection tray system 50.

Movement of the cup vertically is accomplished by a tension element 180 driven by a fixed motor 182 having drive shaft 184 and drive roller 186. The tension element 180 is fixed to the rail 178 so upon actuation of the motor 182, the tension element 180 rotates around driven roller 188 for vertical movement of the rail and thereby also the cup 150.

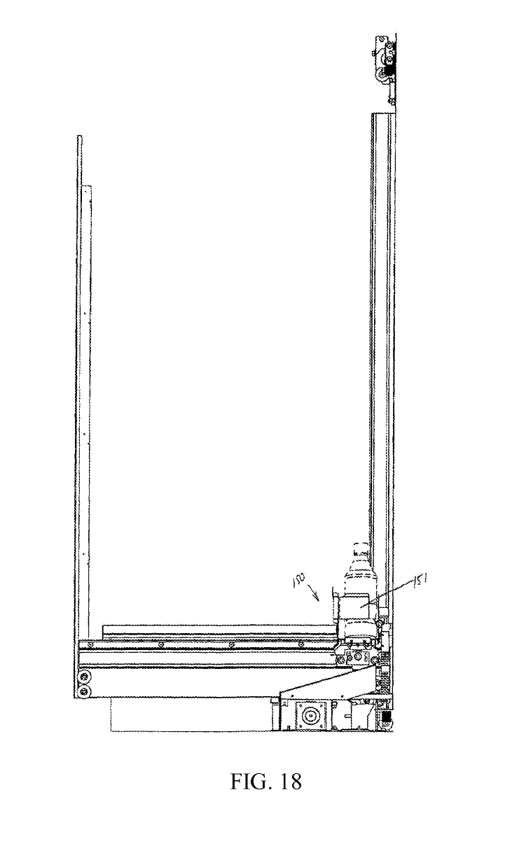

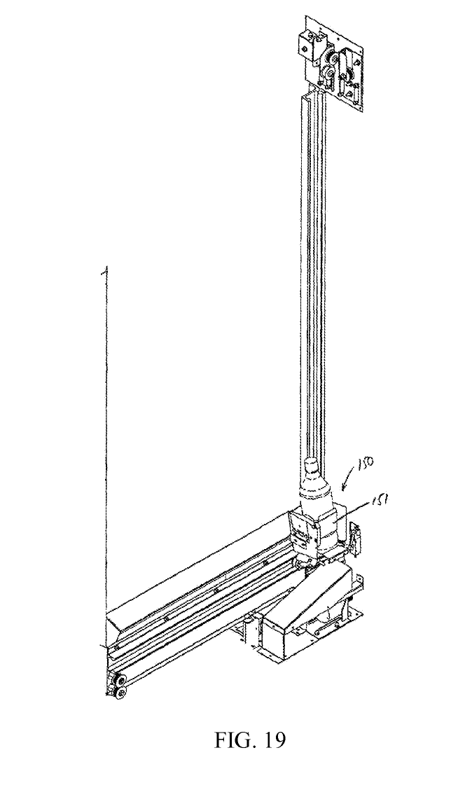

In FIGS. 20 through 22, various views are shown of the positioning of the cup adjacent to a delivery door (not shown). The product is shown in dotted lines, since for illustrative purposes, the elevated position of flange 151 indicates that product should not be present in the cup 150.

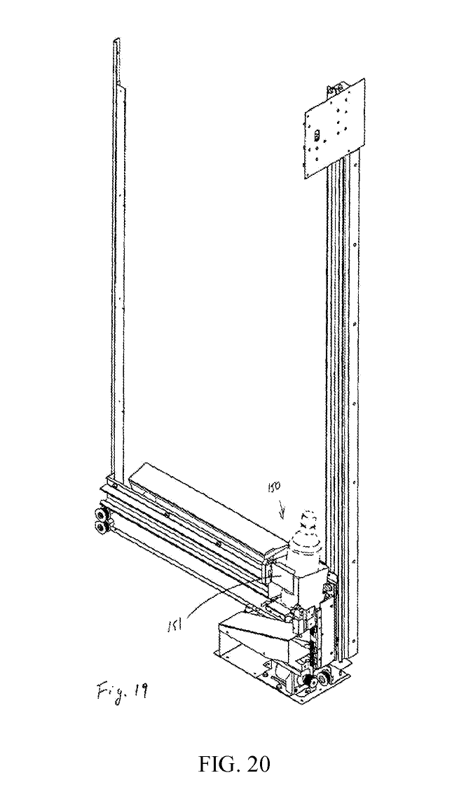

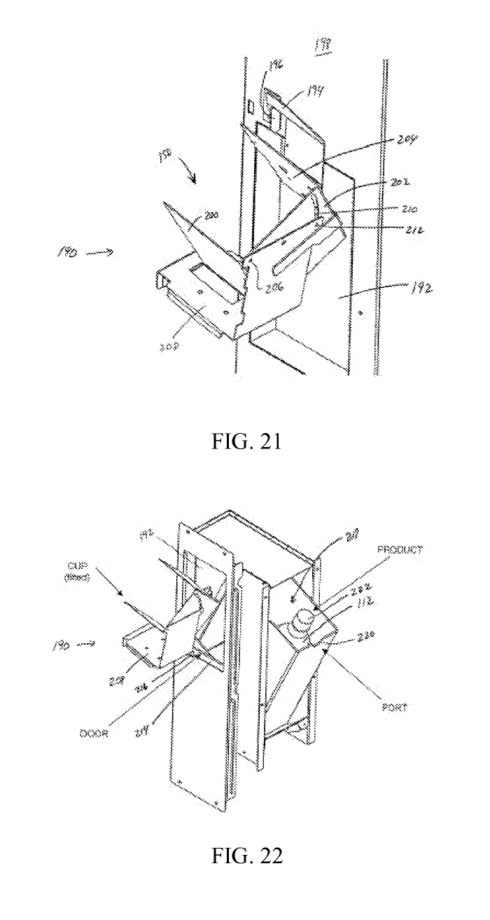

For delivery of product from the cup, the discharge mechanism 150 as shown in FIGS. 22 and 23 is used. The product is delivered through a discharge window 192 by engagement of an upper wall portion 194 of the cup 150 with a projecting tab 196 fixed on a sidewall 198 of the discharge port. Continued downward movement of the cup causes three interconnected sidewalls 200, 202, 204 of the cup to pivot around pivot point 206. The sidewalls 200, 202 and 204 engaging a product, tilt the product until the bottom of the product clears the bottom wall 208 of the cup to allow the product to slide at an angle of approximately 45 degrees into open delivery window 192. Smooth movement of the sidewalls 200, 202 and 204 is ensured by a cam slot 210 of wall 202 passing along a fixed screw or a bolt, pin or rivet 212.

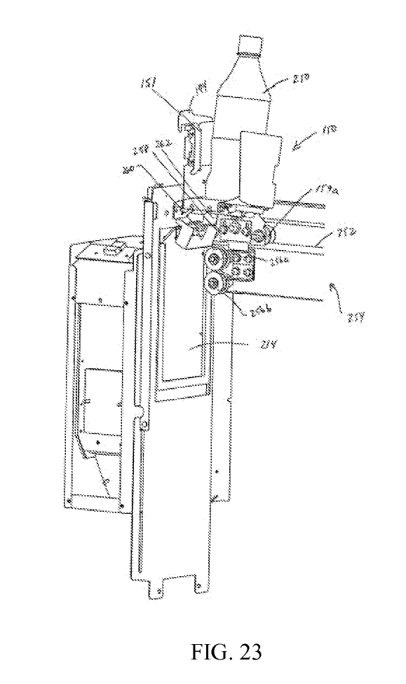

As shown in further detail in FIG. 24, release of product through the window 192 is allowed by the vertical movement of the cup 150 to engage a sliding delivery door 214 which normally covers the window 192 of a delivery box. The door 214 is moved by engagement of an edge of bottom 208 of the cup with a tab 216 of the door. The product is thereby released into a delivery box 218 which is allowed to tilt forward by gravity or by engagement with a finger of the consumer in a finger hole or finger recess 220. The delivery box 218 is tilted so that the product 112 may be grabbed by its cap 222 and removed from the machine.

A mechanism prevents the delivery box 218 from tilting out of the machine until after the door 214 is moved to the retracted position shown in FIG. 23 and the product is dropped into the basket. Not until upward movement of the cup and release of the sliding door, so that the door may cover the delivery window 192, will the basket be allowed to be pivoted towards the consumer for access to the product. The prevention of pivoting of the delivery box 218 until the sliding delivery door 214 is closed, prevents the customer's hand from being injured during delivery of the product into the basket.

FIGS. 24 through 34 illustrate the delivery of product from the elevator cup 150 through the delivery window 192 after opening of the delivery door 214 and passage of the product into the delivery box 218.

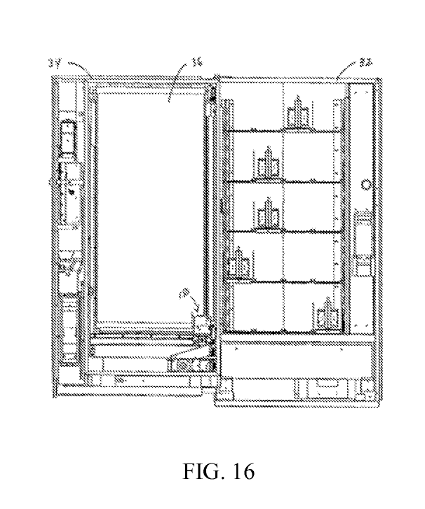

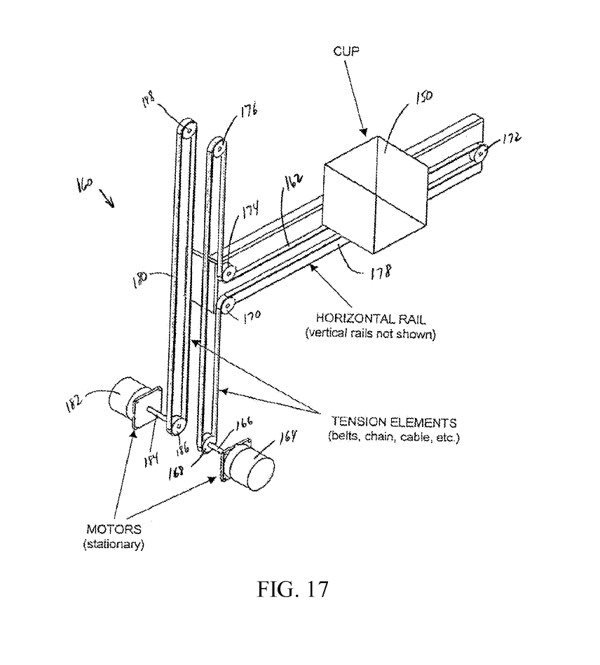

As shown in FIG. 24, the product 250 approaches the delivery door 214 by rollers 159a, 159b and 159c resting upon edge 252 of horizontal rail 254. Horizontal rail 254 is moved vertically as was explained with reference to FIG. 18. Driven rollers 256a, 256b are engaged by a tension element such as a driven chain (not shown), for example, so as to move the elevator cup 150 along the horizontal rail 254.

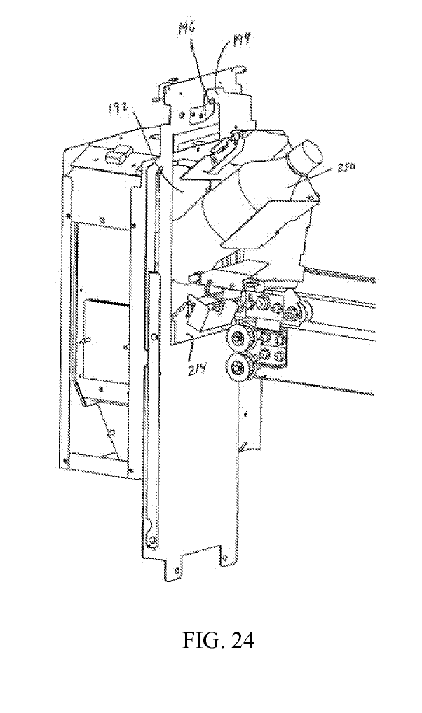

When the delivery cup 150 is in the position shown in FIG. 23, a port latch 258 located adjacent to an uppermost edge 260 of the delivery door 214 is engaged by a horizontally extending flange 262 located underneath the elevator cup 150. As the elevator cup 150 is lowered with the horizontal rail 254, the upper wall portion 194 engages the projecting tab 196 as was explained with reference to FIG. 22 and as shown in FIG. 25. Simultaneously, the delivery door 214 is lowered vertically to open window 192 so that the bottle or other vending item 250 may be tilted, and by gravity, fed through the delivery window 192. The downward movement of the port latch 258 causes engagement with a weld pin to lock the delivery box in position and prevent the delivery box from being opened. This is a safety feature so that the customer's hand is not inside the delivery box as the product is being dispensed.

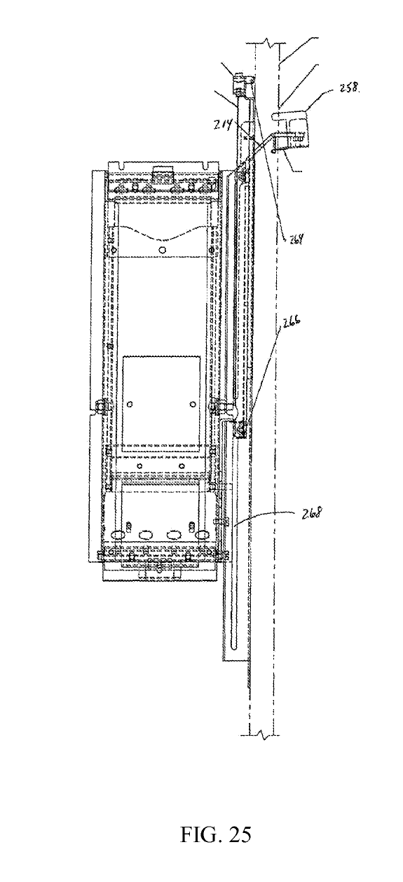

In FIG. 26, the bias force on the delivery door 214 is caused by anchoring a spring at one end on projection 264 whereas the other end of the spring (not shown) is secured to a projection 266 located at the bottom of the delivery door 214. The door 214 slides in guide track 268 to ensure smooth movement.

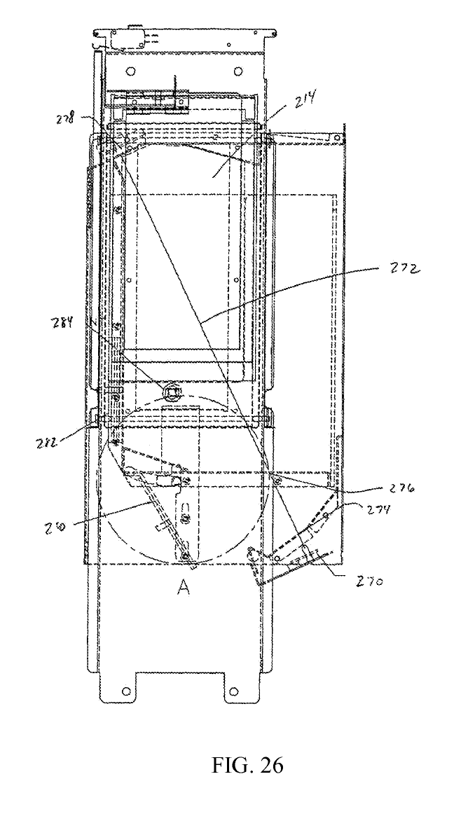

As shown in FIG. 27 from the opposite side of the delivery door 214, turned 90 degrees from that shown in FIG. 26, an optic sensor emitter board 270 projects light beam 272 through holes 274, 276 so that the line of sight with optic sensor detector board 278 is clear. When a clear line of sight is present, a signal is produced indicating that the delivery box is in position to receive a product. Counterweights 280, 282 maintain the position of the delivery box in a closed position until a product is ready to be delivered and the delivery box is pivoted about pivot point 284.

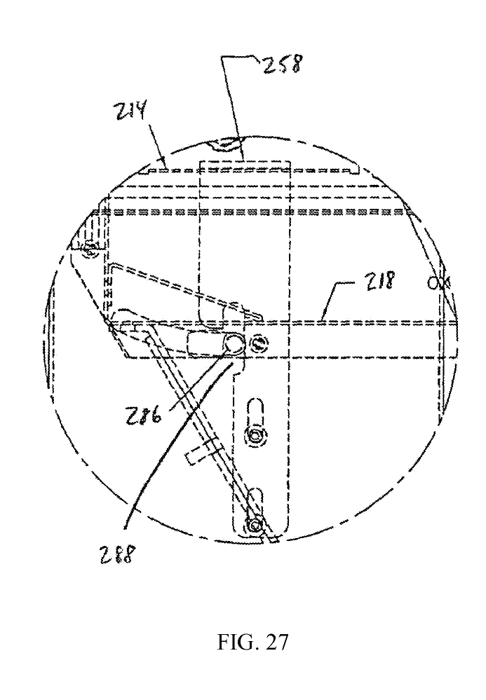

As shown in greater detail in FIG. 28, the area encircled in FIG. 27 illustrates the port latch 258 in a rest position prior to the dispensing of product through the delivery door 214. In this position, the delivery box 218 is movable. Movement is allowed because the port latch 258 has not yet engaged weld pin 286 in groove 288 of the port latch.

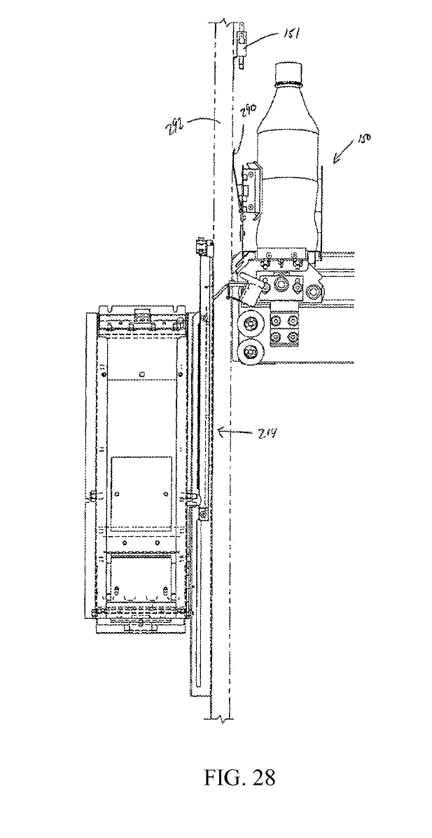

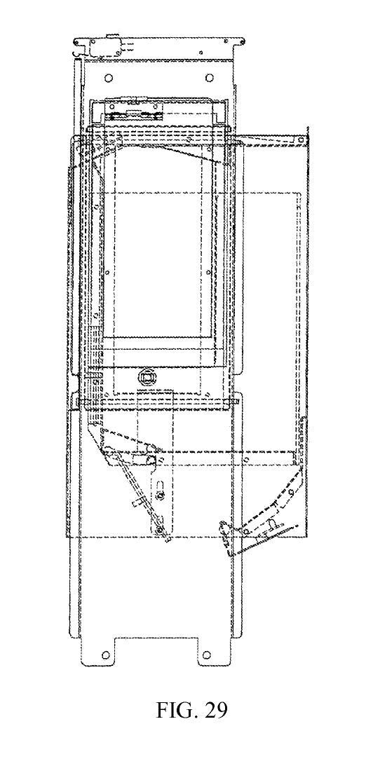

In operation, when the elevator cup 160 approaches the delivery door 214 as shown in FIG. 29, a sensor switch 290 indicates engagement with the exterior wall 292 of the vending machine. The downward movement of the elevator cup first opens the port latch and then contacts the delivery door as shown in FIG. 30.

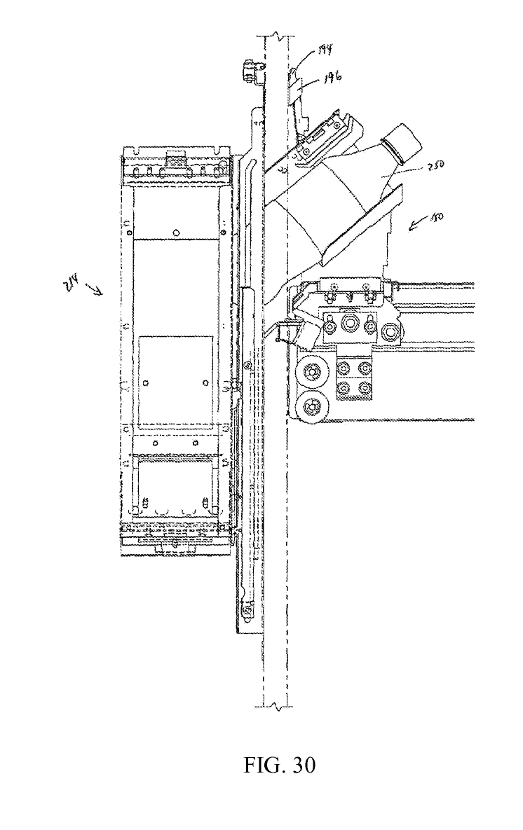

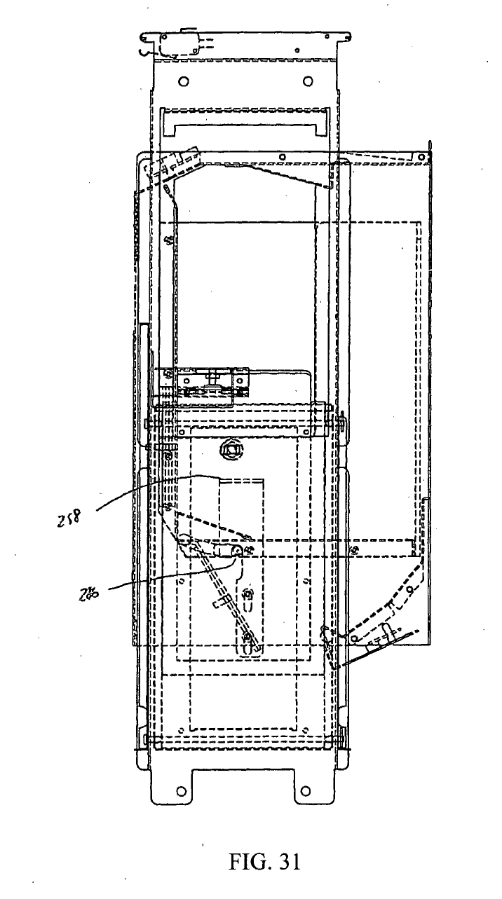

As shown in FIG. 31, the elevator cup 150 has completely opened the delivery door. The product 250 is delivered to the delivery box 214. The delivery box is maintained in position by engagement of the port latch with the weld pin 286 as shown in FIG. 32. This prevents the delivery box from being opened.

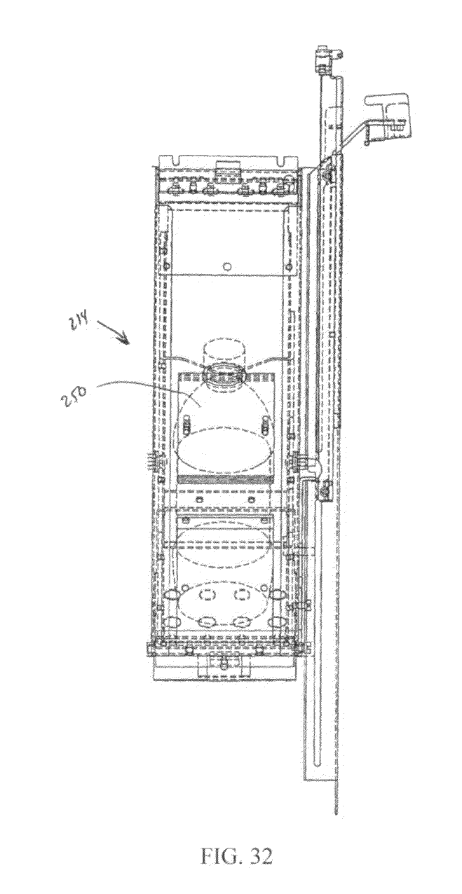

As shown in FIG. 32, the bottle or other vending item 250 is located within the delivery box 214 so that, as shown in FIG. 33, after upward movement of the door 214, the weld pin 286 is released from the port latch 258 and is allowed to travel along arcuate guide groove 290 for controlling the pivotal movement of the delivery box. The weight of the product being vended rotates the delivery box forward to present the product to the customer.

The foregoing description should be considered as illustrative only of the principles of the invention. Since numerous modifications and changes will readily occur to those skilled in the art, it is not desired to limit the invention to the exact construction and operation shown and described, and, accordingly, all suitable modifications and equivalents may be resorted to, falling within the scope of the invention.

In addition to displaying the food items, messages can also be displayed to encourage sales. In one embodiment, an electronic blackboard is provided which is capable of displaying one or more messages depending on the time of day, the season of the year or other conditions. For example, sales or “specials of the day” can be displayed.

Any reliable payment system can be used in connection with the above disclosed system. Either cash or cashless payments are specifically contemplated. The remote location can be equipped with a device that enables automatic cash purchases, such as a currency reader. Specific cashless payment devices contemplated include payments via: credit card, debit card, ATM card, various prepaid debit cards, etc. In the later cases, the remote location can include a card reader. The cash-less payment modes are particularly convenient in view of the price of the various goods being offered which will be in the price range typically paid by consumers with credit cards and other cash-less payment cards.

Upon occasion, an operator may issue discount coupons, for example during a promotional event. The payment system can be configured to recognize discount coupons. The payment system can be configured to accept the coupon in the same manner that cash is accepted. The system will then read the coupons and deduct the appropriate amount from the food price.

A coupon can have a permanent denomination chosen when the coupon is printed. Alternatively, a value can be assigned to a coupon at a later time. For example, a coupon can be imprinted with a unique machine readable code. The payment system operator then programs a cash credit to be associated with that unique code. When the coupon is presented to the payment system, the credit is deducted from the purchase price.

Cash can be collected from the structure using any standard procedure. Cash can be collected by the same contractor hired to perform other services, such as restocking. Alternatively, a special contractor can be hired to perform cash pickups, for example an armored car carrier. The later embodiment, while more costly, is preferable in instances where a large amount of money is to be collected or when making collections in high crime areas.

The results of these various payment transactions can be monitored and reported in a manner similar to that of the inventory reporting. Telemetry can be obtained either manually or automatically, and can be gathered by visiting to the remote site or by transmittal from the remote site to a database.

In addition to stocking and payment systems, the invention also includes a maintenance system. The various devices at the remote location can be monitored by personal inspection. However, a preferred embodiment comprises a system of automatic monitoring. The status and performance can be manually or automatically monitored and recorded, as described above for other systems.

Telemetry sent from the remote location can be monitored on a round-the-clock basis. As a consequence, a breakdown will be immediately detected and addressed with an appropriate response, even if the breakdown occurs after normal working hours. The breakdowns can be the result of numerous causes; including device malfunction, power failure, vandalism and other causes.

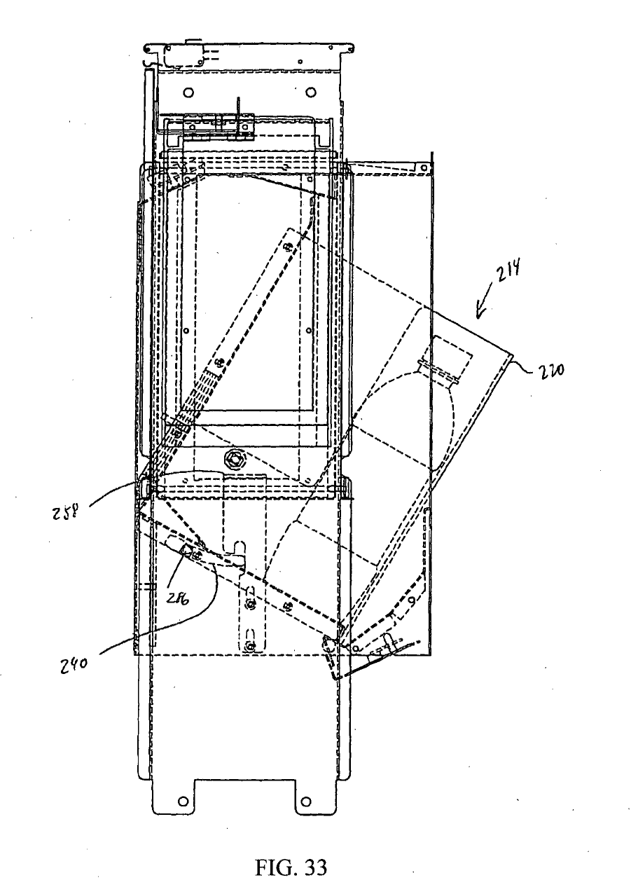

FIG. 34 illustrates a remote embedded application, in the form of a vending machine 1, or plurality of vending machine, which are arranged to communicate with a central site, in the form of an Internet Service Provider (ISP) Server 2, over the Internet. Below we consider a single vending machine; however, it is understood the methods can be easily applied to a plurality of machines. Using the description below the same protocol can be used to allow two machines to communicate to one another.

The vending machine 1 incorporates an intelligent controller 10 which controls the normal functions of the vending machine 1 and also maintains a local database 11 which maintains a record of various parameters at the vending machine 1—e.g. current operating status, performance, stock levels, currency levels, etc. (Some applications may have more than one controller such as 10 to perform and/or control different functions but, for simplicity, reference is made here just to one controller 10, it being well understood by those skilled in the art that this may represent a plurality of controllers.)

The vending machine 1 also incorporates a communications module 12 which includes a module controller 121, a modem 122 and i/o ports 123. Although in FIG. 34 the module controller 121, modem 122 and i/o ports 123 are shown separately from the vending machine controller 10, any or all could alternatively be integrated with it.

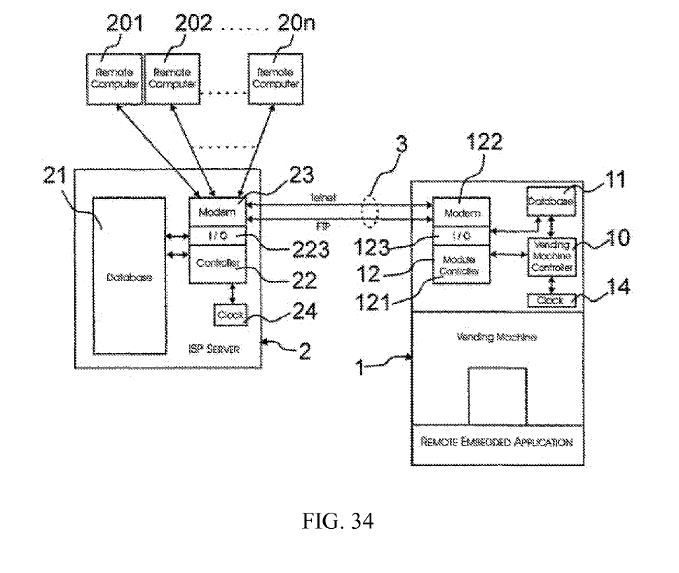

The ISP server 2 is in effect a computer network server which is arranged to communicate simultaneously with a plurality of remote computers 201, 202 . . . 20n. Remote computers 201, 202 . . . 20n could be any of the following: a hand held device, a laptop computer, a database, an internet site, etc. In a preferred embodiment the remote computer 20n is represented by a human, an off-site manager, interfacing with the system by listening to a voice through a telephone or VoIP, replies from the human if necessary can be from a key pad, key board, or translated by voice recognition software. The ISP server 2 further comprises a database 21, a controller 22, i/o ports 223, a modem 23 and a clock 24. For simplicity, the modem 23 is shown as within the ISP Server 2 although, in an Internet configuration, the modem 23 may typically be located at a different site than the database 21, as illustrated in FIG. 35, which is described in more detail below.

A communications link 3 is provided between the vending machine 1 and the ISP server 2. The communications link 3 may take any suitable form but, in this example, utilises the Internet, which is accessed by both the vending machine 1 and the ISP server 2 via their respective modems 122 and 23. However, it is to be understood that the communications link 3 could take any convenient form, which does not necessarily require the use of a modem such as 122 or 23 at either end of the link Both hard wired and wireless links maybe employed, as may both dial-up and permanent connections (e.g. Ethernet, ADSL, Intranet, WAN, etc.).

The vending machine 1, together with the ISP server 2 and the communications link 3, make up a communications system which operates as follows.

When it is desired for the vending machine 1 to communicate with the central database 21, either upon a reportable condition arising at the vending machine 1 or at predetermined periodic intervals, the module controller 121 initiates an Internet dial-up session via the modem 122, and establishes a link with the ISP server 2 (of known IP address). This may be, for example, by way of a Telnet session, with the module controller 121 providing an ID (username/password) to log onto the database 21.

Once the Telnet session has been established, the ISP server 2 synchronizes a local clock 14 of the vending machine 1 with the dock 24 of the ISP server 2. Updating the local vending machine dock 14 in this way enables any necessary time adjustment at the vending machine 1, to provide more accurate synchronization as to time and date, as between the vending machine 1 and the ISP server database 21. Alternatively, the clock 14 of the vending machine 1 may need to be synchronized with the clock 24 of the ISP server 2, only when the module 12 is first installed and powered up (see below).

The communications link 3 having thus been set up, the ISP server 2 establishes an (File Transfer Protocol) session back to the vending machine module 12, which is set up to operate as an FTP Server. To this end, the ISP server 2 looks up from the database 21 an appropriate ID (username/password) for the particular vending machine module 12, to establish the FTP session.

At that point, the ISP server 2 takes control of any necessary exchange of files with the vending machine module 12. It is important to appreciate that, in order to establish such an FTP session, it has not been necessary for the ISP server 2 to initiate a call to the remote embedded application of the vending machine 1. On the contrary, it is the vending machine 1 that has initiated the call. But once the initial (e.g.) Telnet session has been set up, the ISP server 2 then takes over and sets up the FTP session.

Also, since control of the exchange of files in the FTP session between the database 21 and the vending machine module 12 rests entirely with the ISP server 2, substantially all intelligence and control may remain at the ISP server 2, with the vending machine module 12 having only minimal requirements. This arrangement provides substantial flexibility, since “decision making” software need not be embedded in the remote module 12. This allows for much simpler software upgrades to the system. In most case, software upgrades can be accomplished entirely by a single operation at the ISP server 2, rather than at many remote modules such as 12. The absence or minimization of decision-making software at the remote unit 12 minimizes code downloads when new decisions need to be made. The remote unit 12 can request the database server 2 for certain actions—for example, download a specific file. However, the database server 2 can override any requests due to other events—for example, if a PC user (see below) has requested a specific function which takes priority.

With the FTP session established and any necessary time adjustment made as between the ISP server clock 24 and the vending machine dock 14, files can be exchanged between the ISP server database 21 and the vending machine database 11 as necessary. For example, latest vending machine prices may be downloaded from the ISP server database 21 to the vending machine database 11, when the time and date stamping of files indicates that the files at the vending machine 1 require updating. The ISP server database 21, under the control of controller 22, will automatically upload the latest collected data files from the vending machine 1 for example, vending machine stock levels, currency levels, etc. File transfers may take place in response to requests from the module 12 (or a remote computer 201, 202 . . . 20n)—for example, in response to a flag set at the module 12 (or remote computer) to indicate a file transfer request.

Once the files between ISP server database 21 and vending machine database 11 have been synchronized, the ISP server 2 can then teardown the FTP session.

Thus, in this way, significant advantages of ease and cost of communication can be obtained, firstly by making use of the Internet (where local call charges usually apply) to provide communication between the remote embedded application and the ISP server 2, and secondly by employing a relatively simple communications controller 12 in the remote embedded application, to leave intelligence and control of file transfer sessions principally with the ISP server 2. As noted above, there is no requirement for the ISP server 2 to initiate a call to the remote embedded application. The remote embedded application initiates the call, but the file transfer is then set up by the ISP server 2. The transmission of real-time information from the ISP server 2 to the remote embedded application over the initial Telnet session can be particularly advantageous to ensure correct time sequencing of the files at the respective ends of the communications link.

As mentioned above, in an Internet implementation, the modem access may typically be more distributed than shown in FIG. 34. This is shown in more detail in FIG. 35. Here, the remote module 12 connects with an ISP modem server 23a, which provides a local point of presence, and communicates over the Internet 30 with database server 2a, which contains database 21, controller 22 and clock 24. (The clock could be local to the database 21 as shown or derived from another clock source on the Internet network—e.g. an atomic clock source.) Likewise, remote computer 201 (202 . . . 20n) connects with another ISP modem server 23b, which provides another local point of presence, and communicates over the Internet 30 with database server 2a.

In one example of an alternative configuration, the modems and Remote Access Servers of FIG. 35 can be dispensed with and the various components permanently connected, e.g. by way of an Ethernet or Intranet configuration. Either or both of the remote module 12 and remote computer could have respective databases which are either local or remotely connected over the network.

The structure of the ISP server 2 is such as to facilitate the lookup of Public Encryption Keys, which will be different for the Telnet and FTP sessions. The Telnet Public Key will be a key which is common to the ISP server 2, which typically will service a large number of embedded applications, such as the vending machine 1. However, the FTP Public Key can be unique to the vending machine module 12. The latter feature enables a particularly advantageous encryption method, which combines simplicity with high security. This operates as follows.

Once files between the ISP server database 21 and the vending machine database 11 have been synchronized, and before the current FTP session ends, the ISP server 2 can send to the vending machine module 12 a new Public Encryption Key for the next FTP session on the next call from the vending machine module 12. In other words, each time a new FTP session is initiated by the ISP server 2, it uses a Public Encryption Key for the vending machine module 12 (operating then as an FTP Server) which has been transferred as a file to the vending machine module 12 during the previous FTP session. It will be appreciated that this affords a high degree of security. By the same token, it also allows a more simple encryption algorithm to be used for a given degree of security, since data synchronisation FTP sessions between the ISP server 2 and the vending machine module 12 will typically be small and therefore more difficult to crack, when the FTP Public Key is changed dynamically from one session to the next.

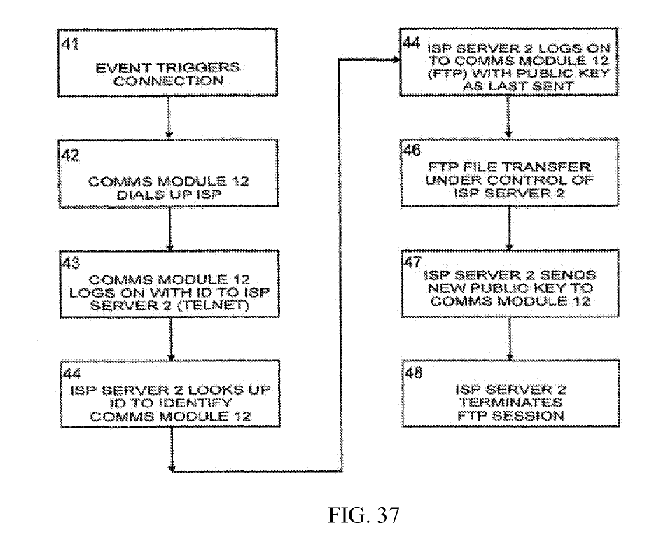

FIG. 37 is a simple flow chart to illustrate the above-described method of establishing a file transfer session between remote embedded application 1 and ISP Server 2, with dynamic Public Key assignment.

In step 41, an event occurs to trigger a connection request between vending machine 1 and ISP Server 2. For example, this may be due to a particular event arising at the vending machine 1, or to a particular time event arising, which requires a routine connection to the ISP Server 2.

In step 42, the communications module 12 dials up the respective Internet Service Provider and, in step 43, logs on to the ISP Server 2 with appropriate ID, by way of a Telnet session.

In step 44, the ISP Server 2 looks up the ID received in the initial Telnet session, in order to identify the particular communications module 12. In step 44, the ISP Server 2 logs on to the communications module 12 to establish an FTP session, using the FTP Public Key as sent to the module 12 during the last file transfer session.

In step 46, file transfer proceeds between the ISP database 21 and the remote application database 11, under control of the ISP Server 2 and, during that file transfer process or at the end of it, the ISP Server 2 sends, in step 47, a new Public Encryption Key to the module 12 for the next FTP session.

With all of the file transfers completed, the ISP Server 2 terminates the FTP session in step 48.

Another preferred and advantageous feature of the illustrated communications system concerns the procedure for first installing the vending machine module 12.

When installed, the vending machine module 12 is programmed with a unique serial number. It is also programmed to dial up and connect to a specific registration database when first installed and powered up in the vending machine 1. In other words, as a new item of equipment, the vending machine module 12 requires only minimal programming. Many similar modules 12 can be programmed in almost exactly the same way with almost exactly the same information, each differing only in its own unique serial number.

When the vending machine module 12 dials up the registration database for the first time, the registration database identifies the specific module 12 by means of its unique serial number, and then programs the module 12 with all of its relevant customized configuration—such as, for example, Telnet and FTP passwords, FTP Public Encryption Keys, telephone numbers for local ISP access local telephone rates), customer name, customized web pages, new user configuration, subsequent database IP addresses, etc. Having been programmed with all of this data, the vending machine 12 is then ready to dial up the ISP server 2 over the communications link 3, as described above, for regular Telnet/FTP sessions. Thus, the installation process for the vending machine module 12 is substantially automated. As indicated above, the initial registration procedure can include an initial dock synchronization step between a central clock such as 24 and the clock 14 of the module 12.

The registration procedure for the remote module 12 is carried out in just the same way as the above-described ISP server access—that is an initial Telnet session followed by an FTP session. This is a real benefit of centralized decision-making as described above. The remote module 12 purely has files transferred through it. It does not need to know whether these are configuration files, as in the case of initial registration, or whether they are data files for normal operation. The registration database could be totally separate from the usual “application” database 21, or it could actually be the same database.

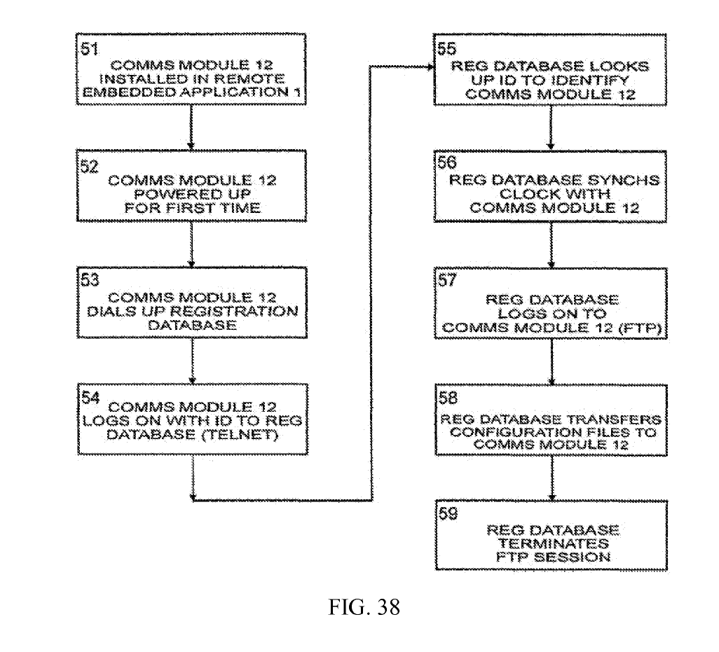

FIG. 38 is a simple flow diagram to illustrate the steps in the above-described registration procedure.

In step 51, the communications module 12 is installed in the remote embedded application 1 and, in step 52, it is powered up for the first time. In step 53, the communications module 12 dials up the registration database and in step 54 logs on to it with its predetermined ID which, as described above, may be its unique serial number, in order to establish a Telnet session.

In step 55, the registration database looks up the ID supplied from the module 12 in order to identify the particular module and then, in step 56, it synchronizes its own local clock (or the clock that it uses) with that of the module 12.

In step 57, the registration database logs on to the communications module 12 to establish an FTP session and, in step 58, it transfers the necessary set up and configuration files to the module 12. When all of this is completed, the registration database terminates the FTP session in step 59.

As noted above, in addition to providing Internet service to a plurality of communication modules such as 12 for various remote embedded applications, the ISP server 2 also provides Internet service for a large number of remote computers 201, 202 . . . 20n which, so far as the ISP server 2 is concerned, will typically be connected as PC Browsers. Thus, a user on remote computer 201, subject to submission of appropriate ID (username/password), can gain access to the database 21 and therefore obtain information as to the current state of the vending machine 1 at the last time a dial up session was established between the vending machine 1 and the ISP server 2. This might be regarded as a “snapshot” in time of the status of the vending machine 1. In this way, subject to suitable security restrictions, an owner of a number of vending machines (or other embedded applications) can view their status conveniently via the database 21, over a relatively cheap and simple Internet connection via the ISP server 2.

In an optional variant, the user of remote computer 201 can look directly at the vending machine 1. This operates as follows.

Once connected to the ISP server 2, the user of computer 201 can cause the ISP server to dial up the vending machine module 12, which is provided with Calling Line Identification (CLI) Service, to indicate to the called module 12 the identity of the calling party. The ISP server 2 will cause the vending machine modem 122 to be called for one or more ring periods (or for a predetermined time, particularly if the CLI comes before the first ring, such that no-ring calls can be supported). The communications module 12 detects from the CLI that the ISP server 2 has called, and is programmed not to answer the call. However, the communications module 12 is programmed to dial back after a short duration to establish a Telnet session (generally as described above) with the ISP server 2, which then in turn establishes an FTP session with the communications module 12, also generally as described above.

Then, furnished with the appropriate IP addresses, the ISP server 2 connects the remote computer 201 directly with the vending machine 1, via the communications module 12. This enables the user of remote computer 201 to view the data in the remote embedded application in real-time, and optionally, exchange data files with it and/or the ISP server 2.

In this way, the user of remote computer 201 (202 . . . 20n) can dial up and view any desired remote embedded application at will, using a communications link established over the Internet. Again, by use of the CLI, one is able to overcome the presently accepted restriction that ISP's will not initiate a call, and thereby ensure that any call charges remain with the owner of the vending machine module 12, rather than being attributed to the ISP server 2.

In the above procedure, the dynamically assigned IP address of the remote module 12 is captured at the database 21 and forwarded to the remote computer 201. This allows the remote computer 201 to browse the module 12 directly, since the module has its own embedded web server. Therefore, this provides a mechanism for the remote computer 201 to interrogate the remote module 12 in real time. So far as the remote module 12 is concerned, it has had a request to synchronize with the database 21, using Telnet/FTP sessions. The database controller 22 can make the appropriate decisions as to whether to transfer files and/or “connect” the remote computer 201 to the remote module 12. For example, the remote computer 201 may update some configuration at the database 21, request that this be transferred immediately to the remote module 12, and request that it view the module 12 in real time to see the effect of the configuration changes. This is another significant benefit of centralized decision-making as described above.

The use of CLI can be extended such that the ISP server 2 may dial any desired remote embedded application at any desired time, in order to initiate a return call from the communications module 12, to establish a Telnet session followed by a FTP session, generally as described above. Thus, the use of CLI is not just reserved for connecting remote computers 201, etc to remote module 12. The remote computer 201 can make changes at the database 21, for one or more remote modules 12. The ISP server 2 could then subsequently use CLI to request that the remote modules 12 synchronize immediately, rather than waiting for predetermined dial up times.

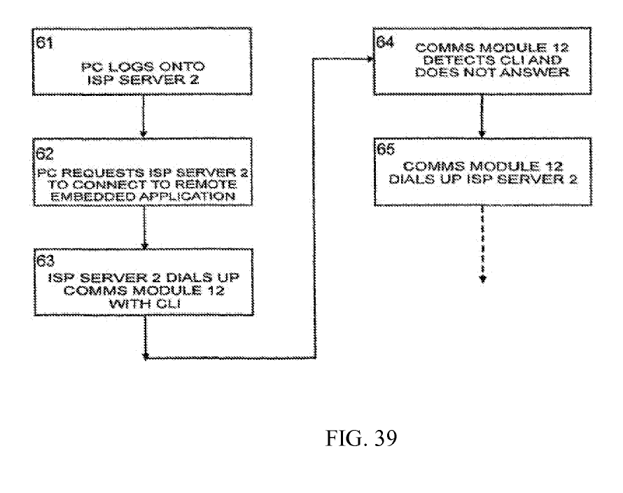

FIG. 39 is a simple flow diagram to illustrate the initial steps in establishing a connection between ISP Server 2 and remote application 1 by use of CLI, as described above.

In step 61, a PC (e.g. remote computer 201) logs on to the ISP Server 2, to establish a typical web browsing session. In step 62, the PC requests the ISP Server 2 to connect to the remote embedded application 1 and, in step 63, the ISP Server 2 dials up the module 12 using CLI. In step 64, the module 12 detects the CLI but does not answer the incoming call. After a predetermined time, the module dials back to the ISP Server 2 in step 65. Thereafter, a file transfer session may be implemented, using techniques as described above, and involving the remote application 1, ISP Server 2 and, optionally, remote computer such as 201. Alternatively or additionally, the remote computer such as 201 may be connected directly to the remote embedded application 1.

During a synchronization process, a direct communication channel could be opened with the remote embedded application 1, thereby allowing real time data to be captured from equipment of the remote embedded application 1, rather than the data as last stored in the local database 11. One way of providing such a channel is described below.

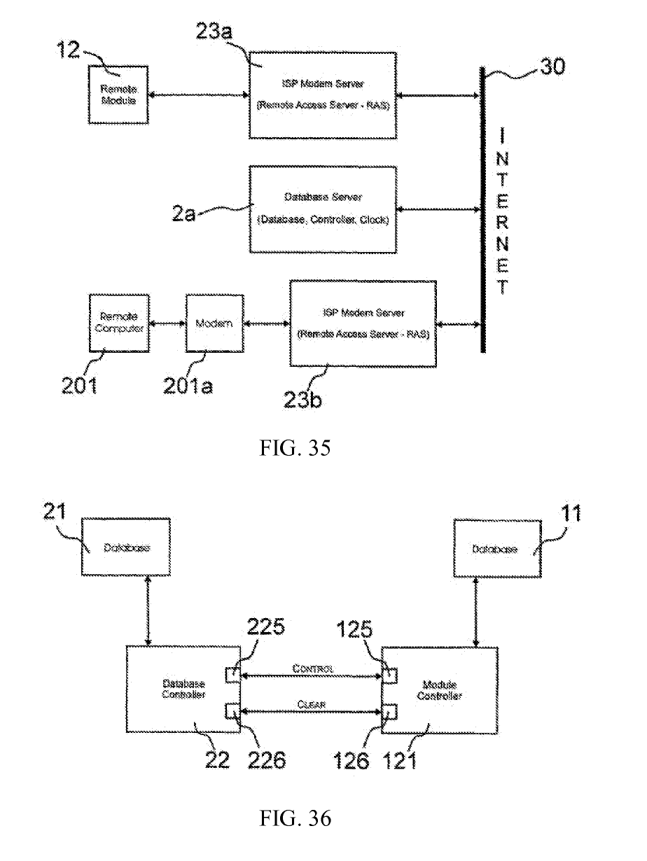

FIG. 36 illustrates an advantageous option for providing data transfer between the ISP database 21 and the vending machine database 11, via their respective controllers 22 and 121. For simplicity, the modems 23 and 122 are not shown in FIG. 3 and, as is evident from the above description, modems are not invariably required anyway, depending upon the kind of network employed.

FIG. 36 illustrates schematically the use of TCP ports and sockets (e.g. Telnet) 125, 126 at the module controller 121 and 225, 226 at the database controller 22, to establish separate CONTROL and CLEAR channels. These are similar to the D-channel and B-channel in an ISDN environment. The CONTROL channel provides end-to-end control information between the remote module controller 121 and the database controller 22, whilst the CLEAR channel is available to exchange pure end-to-end data.

For example, the remote module controller 121 may connect to the database controller 22, using the CONTROL channel established between TCP ports and sockets 125 and 225. A data transfer command or request is transmitted between the database controller 22 and the remote module controller 121 (in either direction) to indicate that it is wished to transfer data from the remote database 11 into a file on the ISP database 21. If it is not already established, the CLEAR channel is set up between TCP ports and sockets 126 and 226, and data is them streamed over the CLEAR channel to the database controller 22, which captures the data in a file in the database 21. During the data transfer process, the CONTROL channel between TCP ports and sockets 125 and 225 provides end-to-end control—for example, STOP, START, PAUSE, etc; or can provide remote control commands to attached equipment—e.g. PAN/TILT commands whist capturing real compressed video images.

The above basic mechanism allows the ISP server 2 to act as a kind of “telephone exchange” between remote computers 201, 202, etc and remote embedded applications such as 1 which have no direct human control. It may be particularly advantageous when used in conjunction with the CLI ring back procedure that is described above. It may enable higher levels of service to be provided, which may be similar to telephony environments—for example, automatic divert of a TCP/IP session from the database 21 to remote computer 201, 202, etc—under the control of decision making at the database server 2.

Although the Internet has been given as one very convenient example, it is to be understood that the ISP server 2 may be replaced by any computer network server which effectively is arranged to communicate simultaneously with a plurality of remote computers, whether on a local, large area, national, international, or global network Embodiments of the invention may be used with advantage in environments which include Internet, Extanet, Intranet, and private or public packet switched or circuit switched networks.

It is to be further appreciated that, in the above described examples, the protocols of Telnet and FTP are just examples or many different kinds of protocols that may be utilized. For example, UDP (User Datagram Protocol) may be utilized as a protocol that is part of the TCP/IP suite of protocols. Instead of Telnet, any file transfer protocol, mechanism or procedure may be used. Instead of FP, one may use any standard or proprietary protocol transferred over a TCP or UDP port or socket.

In a preferred embodiment, a contractor is hired to service the machine. This contractor can be the same one used to provide other services, such as restocking. Alternatively, a special contractor can be used to service the machines. In still another embodiment, routine service can be provided by one contractor but more serious breakdowns are handled by specialized contractors.

With respect to the locations of the remote food service, any location away from the consumer's home refrigerator is specifically contemplated. Examples include: campgrounds (private, state and federal), marinas, parks, urban parks, state parks, national parks, picnic areas, sporting grounds, parking lots of sports stadiums, sites for tailgate parties, etc.

### SUMMARY OF MAJOR ADVANTAGES OF THE INVENTION

The remote location of the disclosed food service relieves the traveler of concerns about packing and preserving food for use in outdoor cooking.

The fully automatic features, including automated sale of the butcher shop food items as well and the off site servicing of the disclosed food service relieve the remote site manager of any significant duties toward managing the food service.

The categories of food items offered for sale at the remote location will include a significant portion of those food items offered at butcher shops thus providing butcher shop services at a remote location.

The subject retail shops allow the service to be offered on a round-the-clock basis.

The automation features also allow a butcher shop to offer its services at remote locations without having to hire on site staff to collect payment and dispense the food item to the customer.

The automation and data systems allow efficient management of the remote butcher shop through off site monitoring of the status of the remote butcher shop.

Furthermore, the data systems with their automatic recording systems will free the remote site manager from the need to report on the status of the remote butcher shop.

Systems that communicate data from the remote site to offsite locations allow for the efficient management of a plurality of remote butcher shops. The plurality of shops are configured to report to managers at a relatively few offsite locations or even to a single manager at a single offsite location.

1. A dispensing system for the delivery of butcher shop meat items to a customer comprising:
a plurality of portable structures each configured to maintain environmental conditions suitable for maintaining butcher shop meat items in a maintenance condition, each containing a selected set of butcher shop meat items positioned within said portable structure, each containing a dispensing apparatus configured for the dispensing of said butcher shop meat items, wherein said dispensing system requires said customer to provide payment before said butcher shop meat items are dispensed, whereby butcher shop services are dispensed to the customer without the presence of local personnel;
a system connected to said portable structures for the remote managing of said payments; and
a system connected to said portable structures for remote management of meat items inventory; wherein each portable structure is configured to communicate data from the portable structure to at least one remote location being selected from the following list: a hand held device, a laptop computer, a database, an internet site and an off-site manager.
